(19) United States
(12) Patent Application Publication
(10) Pub. No.: US 2026/0217943 A1
(43) Pub. Date: Jul. 30, 2026

(54) PROCESS FOR DEPOLYMERIZING POLYALKYLENE TEREPHTHALATES IN MIXTURES WITH LOWER-MELTING POLYOLEFINS

(71) Applicant: Evonik Operations GmbH, Essen (DE)

(72) Inventors: Christian ZANDER, Hanau (DE); Philip Heinrich REINSBERG, Rheinbach (DE); Johannes RUWWE, Hanau (DE); Adrian BLUM, Huerth (DE)

(73) Assignee: Evonik Operations GmbH, Essen (DE)

(21) Appl. No.: 19/149,154

(22) PCT Filed: Jan. 17, 2024
(86) PCT No.: PCT/EP2024/051028

§ 371 Date: Jul. 18, 2025

(30) Foreign Application Priority Data
Jan. 23, 2023 (EP) 23152835.7

(51) Int. Cl. C08J 11/26

(52) U.S. Cl. CPC C08J 11/26; C08J 2323/06; C08J 2367/02

(57) ABSTRACT

The invention relates to a process for depolymerizing at least one polymer P₁ in polymer mixtures comprising, as well as the at least one polymer P₁, also at least one polyolefin PO that has a lower melting point than P₁ and is especially a polyethylene PE or polypropylene PP. The polymer P₁ is a polyalkylene terephthalate i.e. a polymer comprising terephthalic acid units and alkylene glycol units, in particular polyethylene terephthalate PET or polybutylene terephthalate PBT.

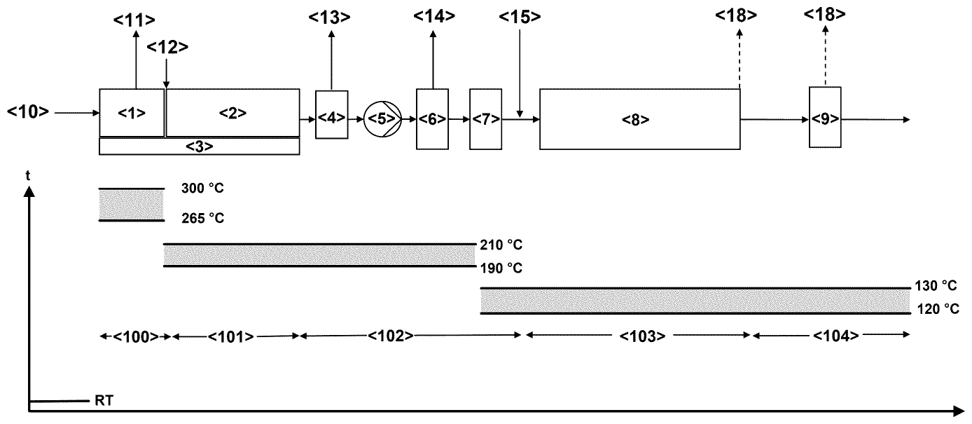

The process according to the invention comprises two steps, wherein the polymer P₁ is reacted in the first step with a glycol compound G essentially to give cleavage products P₂ having shorter chain lengths than P₁. In the second step, the cleavage products P₂ and any polymers P₁ unconverted in the first step are reacted with additionally added glycol compound G and at least partly split into the monomer units. The first step is conducted above and the second step below the melting temperature T_{PO} of the polyolefin PO. This enables simple and efficient separation of the solid polyolefin PO from the mixture obtained after the second step has ended.

The invention relates to a process for depolymerizing at least one polymer P₁ in polymer mixtures comprising, as well as the at least one polymer P₁, also at least one polyolefin PO that has a lower melting point than P₁ and is especially a polyethylene PE or polypropylene PP. The polymer P₁ is a polyalkylene terephthalate i.e. a polymer comprising terephthalic acid units and alkylene glycol units, in particular polyethylene terephthalate PET or polybutylene terephthalate PBT.

The process according to the invention comprises two steps, wherein the polymer P₁ is reacted in the first step with a glycol compound G essentially to give cleavage products P₂ having shorter chain lengths than P₁. In the second step, the cleavage products P₂ and any polymers P₁ unconverted in the first step are reacted with additionally added glycol compound G and at least partly split into the monomer units. The first step is conducted above and the second step below the melting temperature T_{PO} of the polyolefin PO. This enables simple and efficient separation of the solid polyolefin PO from the mixture obtained after the second step has ended.

### BACKGROUND OF THE INVENTION

Polyethylene terephthalate (=“PET”) is one of the most important plastics, which is used in textile fibres, as films, and as material for plastic bottles. In 2007 alone, the volume used in plastic bottles was ~10⁷ t (W. Caseri, Polyethylenterephthalate, RD-16-03258 (2009) in F. Böckler, B. Dill, G. Eisenbrand, F. Faupel, B. Fugmann, T. Gamse, R. Matissek, G. Pohnert, A. Rühling, S. Schmidt, G. Sprenger, RÖMPP [Online], Stuttgart, Georg Thieme Verlag, January 2022).

On account of its persistence and the volumes of refuse originating from PET, it constitutes one of the greatest environmental challenges at present. A similar problem exists for other polyalkylene terephthalates similar to PET, for example polybutylene terephthalate (“PBT”).

The solution to this problem lies in the avoidance and in the efficient reutilization of these plastics.

The prior art proposes multiple methods of cleavage of PET.

GB 784,248 A describes the methanolysis of PET.

Hydrolytic processes for depolymerization of PET are described by JP 2000-309663 A, U.S. Pat. No. 4,355,175 A and T. Yoshioka, N. Okayama, A. Okuwaki, Ind. Eng. Chem. Res. 1998, 37, 336-340.

The reaction of PET with glycol compounds is described in U.S. Pat. No. 3,884,850, EP 0 723 951 A1, U.S. Pat. No. 3,222,299 A, WO 2020/002999 A2, by S. R. Shukla, A. M. Harad, Journal of Applied Polymer Science 2005, 97, 513-517 (“Shukla & Harad” hereinafter) and by N. D. Pingale, S. R. Shukla, European Polymer Journal 2008, 44, 4151-4156.

Shukla & Harad state that the glycolysis of PET gives rise to bis(2-hydroxyethyl) terephthalate (=“BHET”). This cleavage product may simultaneously be used as reactant for production of new PET.

S. Ügdüler, K. M. Van Geem, R. Denolf, M. Roosen, N. Mys, K. Ragaert, S. De Meester, Green Chem. 2020, 22, 5376-5394 (“Ügdüler et al.”) investigates the aqueous alkaline hydrolysis of PET wastes to afford ethylene glycol and terephthalic acid (=TS), in particular the influence of certain reaction parameters such as temperature, ethanol/water ratio etc. on the rate of depolymerization. Ügdüler et al. also discuss the problem of contamination of the PETstarting material with additional polymers such as low-melting polyolefins (“polyolefin” is abbreviated to “PO” below).

In addition to these processes there is multiplicity of processes in which PET-containing wastes are cleaved in an extruder and then worked up.

U.S. Pat. No. 5,545,746 A describes the depolymerization of PET wastes in an extruder to afford ethylene glycol and TS.

L. Biermann, E. Brepohl, C. Eichert, M. Paschetag, M. Watts, S. Scholl, Green Process. Synth. 2021, 10, 361-373 (“Biermann et al.”), which relates to U.S. Pat. No. 5,545,746 A, and WO 2020/053051 A1 describe the hydrolysis of mixed wastes (PET/PE) to give ethylene glycol and terephthalic acid (=“TS”) in a twin-screw extruder using solid sodium hydroxide.

M. A. Mohsin, T. Abdulrehman, Y. Haik, Int. J. Chem. Eng. 2017, 5361251 (“Mohsin et al.”) describes the reaction of molten PET with ethylene glycol in an extruder. However, Mohsin et al. describe neither the use of ethyleneglycolate nor the presence of additional polymers in the PET.

B. Bergmann, W. Becker, J. Diemert, P. Elsner, Macromol. Symp. 2013, 333, 138-141 (“Bergmann et al.”) describe the reaction of molten PET with ethylene glycol in an extruder and the analysis of the extrusion product by near-infrared spectroscopy. The reaction regime is the same as that described by Mohsin et al.

U. Thiele gave a presentation about a corresponding process for PET glycolysis in an extruder at the “5th China International Recycled Polyester Forum”, which took place from 2 to 4 Sep. 2009 in Shanghai, China, in the context of an overview of various processes for PET depolymerization. This presentation is retrievable from http://www.ccfei.net/upfile/conference/200909181532368708140.pdf (“Thiele”), last retrieved 15 Jan. 2023.

J. D. Patterson discloses, on pages 60 ff. of the thesis

“Continuous Depolymerization of Poly (ethylene terephthalate) via Reactive Extrusion” (North Carolina State University, 28 Mar. 2007, retrievable from https://repository.lib.ncsu.edu/bitstream/handle/1840.16/3783/etd.pdf?sequence=1; “Patterson”, last retrieved 15 Jan. 2023) a process for PET glycolysis in an extruder. This too employs ethylene glycol but not ethyleneglycolate. Patterson also quotes the article G. Colomines, F. Rivas, M.-L. Lacoste, J.-J. Robin, Macromolecular Materials and Engineering 2005, 290, 710-720 (“Colomines et al.”). It describes the glycolysis of PET with diethylene glycol and the use of the reaction product in polyurethane formulations.

M. Dannoux, P. Cassagnau, A. Michel, Can J Chem Eng 2002, 80, 1075-1082 describes the alcoholysis of PET in an extruder using dibutyltin oxide as catalyst.

U.S. Pat. No. 3,884,850 describes a process for depolymerization of PET in which PET is converted to BHET and low molecular weight oligomers of BHET.

The cleavage of polyesters, for example polyalkylene terephthalates, in apparatuses typical for polymer processing, for example extruders, is typically performed at temperatures above the melting temperature of the polyester to plasticize the material.

It has now been observed that, in hydrolyses and especially solvolyses of polyalkylene terephthalates such as PET, PBT and similar polyesters in melts that additionally also include polyolefins having a lower melting point than the polyester, such as polyethylene PE or polypropylene PP, the corresponding polyolefin, after conclusion of the depolymerization and cooling of the reaction mixture, agglomerates in such a way that the corresponding agglomerates contaminate the apparatus and are difficult to separate from the crude product. This is disadvantageous since depolymerization of the corresponding polyalkylene terephthalates proceeds very slowly at low temperatures where the corresponding polyolefins are in the reaction mixture in solid form from the start and is economically unviable.

It was therefore an object of the present invention to provide an improved process that does not have these problems for depolymerization of polyalkylene terephthalates, such as PET and PBT in particular, in a mixture with polyolefins having a lower melting point than the polyalkylene terephthalate. This process was especially to enable an efficient and easily performable removal of the polyolefins, and to avoid viscous deposits in the apparatus used.

A process which solves the problem described above has now surprisingly been found.

### BRIEF DESCRIPTION OF THE INVENTION

It has been found that, surprisingly, the described problems of aggregation and coagulation of the polyolefin can be avoided when the depolymerization of the polyalkylene terephthalate (polymer P₁) is conducted in two steps, wherein the first step is conducted at a temperature at which the polyolefin is in molten form. This first depolymerization is conducted with a first portion P_{G1} of at least one glycol compound G and is run in such a way that the polymers P₁ are not cleaved completely into the monomer units [corresponding to the below-mentioned compounds of structural formula (III)], but rather preferentially to a maximum proportion of oligomeric cleavage products P₂.

The reaction solution obtained in the first step is then cooled to a temperature T_{b} at which the polyolefin is in the solidified state, and then the second portion P_{G2} of the at least one glycol compound G is added in order to complete the depolymerization of the polymer P₁, while the polyolefin is in the solid state of matter. It is then possible to separate the solid polyolefin efficiently and with low complexity from the reaction solution obtained after the second step.

### FIGURE

The FIGURE shows an embodiment of the process according to the invention.

In this FIGURE, a waste stream <10> which is at room temperature (“RT”) and comprises PET, polyethylene (=PE) and sand as a solid contaminant V is fed into an extruder E <3>. It is also possible to use a kneader rather than an extruder.

In the extruder E <3>, PET and PE from the waste stream <10> are melted in a first housing <1> within a temperature range of 265° C. to 300° C., and volatile constituents <11> are removed by degassing from the resultant PE/PET melt (corresponding to mixture M₁) <100>.

In a second housing <2>, a first portion P_{G1} <12> of ethylene glycol is then added to the mixture M₁ <100>. Together with the ethylene glycol, in particular, a catalyst K₁ such as sodium ethyleneglycolate or sodium methoxide, for example, is added, preferably in solid form. In the housing <2>, the PET is converted by glycolytic cleavage at a temperature of 190° C. to 210° C., at which PE is in molten form <101>. Also present in the melt <101>, because of the reaction of the PET with ethylene glycol, are “BHET oligomers” (corresponding to the below-mentioned cleavage product P₂ with a″=2, c″=0, a_{♥}=2, c_{♥}=0) and monomer units such as mono(2-hydroxyethyl) terephthalate MHET and bis(2-hydroxyethyl) terephthalate BHET. In addition, the melt <101> also includes ethylene glycol.

After the reaction in the housing <2>, the mixture M₂ <102> comprising not only the BHET oligomers and monomer units but also a solid contaminant V is obtained. Coarse impurities <13> and fine impurities <14> (down to particle size 1 μm) such as sand are removed therefrom by means of coarse filter <4> and fine filter <6> using a pump <5>. After passing through the fine filter <6>, mixture M₂ <102> is cooled in a reaction vessel <7> to a temperature T_{b} in the range from 120° C. to 130° C., which results in solidification of PE in the mixture. Addition of a second portion P_{G2}<15> of ethylene glycol affords the mixture M₃ <103>, which is reacted further with the ethylene glycol in a stirred tank reactor <8>, further cleaving the BHET oligomers in the mixture M₃ <103>, which affords a mixture M₄ <104> comprising monomer units such as BHET and MHET or else terephthalic acid (“TS”). It is then possible to separate the solidified PE <18> from this mixture M₄ in a further filter <9> without any great difficulty. Alternatively or additionally, the solidified PE <18> is skimmed off from the stirred tank <8>.

The coordinate system shown in the lower half of the FIGURE shows the temperature t of the respective mixture (y axis) and the process coordinate (progress of the process; x axis).

### DETAILED DESCRIPTION OF THE INVENTION

The process according to the invention is a process for depolymerizing at least one polymer P₁.

The compounds BHET, MHET and TS mentioned in the context of the present invention have the following structures:

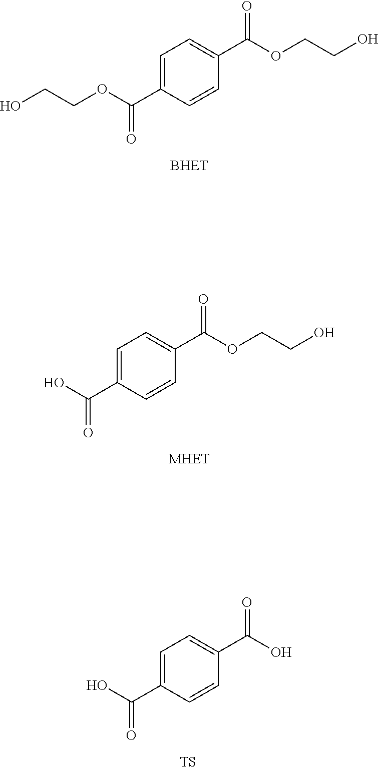

“MHET” also encompasses the corresponding carboxylate of the structure shown.

“TS” also encompasses the corresponding mono- and dicarboxylate of the structure shown.

### 1. Mixture M₁

In step (a) of the process according to the invention, a mixture M₁ comprising
the at least one polymer P₁,
a melt of at least one polyolefin PO having a lower melting temperature than the at least one polymer P₁,
optionally at least one cleavage product P₂,
optionally at least one compound of the formula (III),
   is used.

The process according to the invention is thus especially suitable for processing of wastes comprising a polymer P₁, especially PBT and/or PET, preferably PET, and at least one polyolefin PO which is preferably polyethylene PE or polypropylene PP, more preferably polyethylene PE. Such wastes may be used as mixture M₁ in step (a) of the process according to the invention.

The process according to the invention can thus be used to process wastes especially comprising polyalkylene terephthalates and polyolefins having a lower melting temperature, preferably wastes comprising corresponding multilayer systems.

### 1.1 Polymer P₁

The at least one polymer P1 comprises n₁ interlinked repeating units of the following structural formula (I):

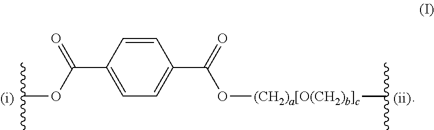

a is an integer where 2≤a≤6, in particular a=2 or 4, preferably a=2.

b is an integer where 2≤b≤6, in particular b=2 or 4, preferably b=2.

c is an integer where 0≤c≤10, in particular c=0 or 1, preferably c=0.

n₁ is an integer ≥50.

The n₁ interlinked repeating units of structural formula (I) encompassed by the polymer P₁ are the same or different, in particular the same.

The n₁ interlinked repeating units of structural formula (I) are interlinked within the polymer P₁ in such a way that the bond of the one repeating unit of structural formula (I) labelled “(i)” is linked to the bond of the adjacent repeating unit of the structural formula (I) labelled “(ii)”.

The process according to the invention is particularly suitable for depolymerization of polymers P₁ which at least in part comprise segments of polyethylene terephthalate [“PET”; following option (β)] or sections of polybutylene terephthalate [“PBT”; following option (α)].

Preference is therefore given to one of the following embodiments (α) and (β), wherein (β) is more preferred:

(α) The polymer P₁ comprises n₁ interlinked repeating units of structural formula (I) where a=4, c=0.

(β) The polymer P₁ comprises n₁ interlinked repeating units of structural formula (I) where a=2, c=0.

The end group of the first repeating unit of the n₁ interlinked repeating units of the polymer P₁ which is present for said units in the structural formula (I) at the bond defined by “(i)”, and the end group of the n₁th repeating unit of the n₁ interlinked repeating units of the polymer P₁ which is present for said units in the structural formula (I) at the bonds defined by “(ii)” are not particularly limited and are a consequence of the method used in the production method of the polymer P₁.

For instance, these end groups may be termination fragments of a repeating unit of structural formula (I) or may be one or more repeating units W_{X}, wherein W_{X} is distinct from the structural formula (I).

It is preferable when at least one of these two end groups is selected from:
H;
OH;
optionally at least one group selected from aliphatic radical comprising —OH, —O— (which may in particular be a group, optionally at least one group, selected from alkyl group comprising —OH, —O—);
aromatic radical [such as in particular an isophthalic acid radical of the below-mentioned structural formula (VII)];
heteroaromatic radical.

It is more preferable when at least one, preferably both, of these end groups is selected from:
H;
OH;
optionally at least one group selected from alkyl group comprising —OH, —O—;
isophthalic acid radical of the below-mentioned structural formula (VII).

It is more preferable when the end group connected to the bond labelled “(i)” in the structural formula (I) is selected from —H, —(CH₂)_{a*}—[O—(CH₂)_{b*}]_{c*}—OH.

a* is an integer where 2≤a*≤6, in particular a*=2 or 4, preferably a*=2.

b* is an integer where 2≤b*≤6, in particular b*=2 or 4, preferably b*=2.

c* is an integer where 0≤c*≤10, in particular c*=0 or 1, preferably c*=0.

Irrespective of this, the end group connected to the bond labelled “(ii)” in the structural formula (I) is preferably selected from the group consisting of —H, —OH, a radical of structural formula (IV) or (VII), more preferably from the group consisting of —H, —OH, a radical of structural formula (IV), yet more preferably from the group consisting of —OH, a radical of structural formula (IV), wherein the structural formulae (IV) and (VII) are as follows:

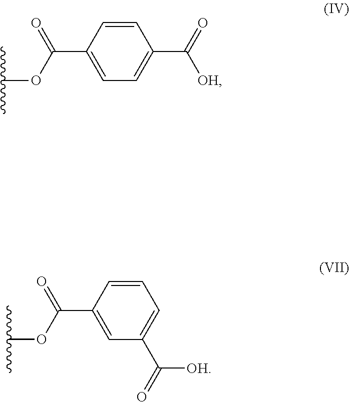

The process according to the invention may thus also be used for depolymerization of polymers P₁ which in addition to the n₁ interlinked repeating units of structural formula (I) comprise further repeating units W_{Y} distinct therefrom. This is the case for example for polymers P₁ which comprise comonomer units such as in particular repeating units of below-mentioned formula (VI) in which a, b, c have the above-mentioned definitions:

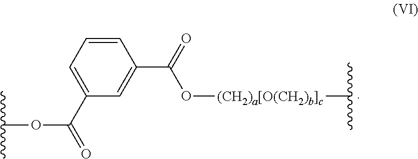

The polymer P₁ according to the present invention thus comprises any polymer comprising at least one segment A₁ which consists of n₁ interlinked repeating units of structural formula (I) which are identical or different, preferably identical, within segment A₁ and wherein the n₁ interlinked repeating units of structural formula (I) are interlinked within section A₁ in such a way that the bond of the one repeating unit of structural formula (I) labelled “(i)” is linked to the bond of the adjacent repeating unit of the structural formula (I) labelled “(ii)”.

In addition to the n₁ interlinked repeating units of structural formula (I) the polymer P₁ may comprise further, preferably organic, groups G_{F}, which are not composed of repeating units of the structural formula (I), for example oligomer sections or polymer sections composed of repeating units W_{Z} distinct from structural formula (I).

For example, a section A₁ composed of the n₁ interlinked repeating units of structural formula (I) may then be linked with such organic groups G_{F} within the polymer P₁ via bond (i) of the first repeating unit of the n₁ interlinked repeating units of structural formula (I) in section A₁ and/or via bond (ii) of the n₁th repeating unit of the n₁ interlinked repeating units of structural formula (I) in section A₁.

Similarly, the polymer P₁ may also comprise two or more sections A₁, A₂ etc. which are each composed of n₁ interlinked repeating units of structural formula (I) and are connected to one another via organic groups G_{F} distinct from structural formula (I), for example oligomers or polymers composed of repeating units W_{Ā} distinct from structural formula (I), wherein these organic groups G_{F} bond to bond (ii) of the n₁th repeating unit of the first section A₁ and bond (i) of the first repeating unit of the following section A₂.

In a preferred embodiment of the present invention, the polymer P₁ has n₁ interlinked repeating units of structural formula (I), wherein the proportion of repeating units of structural formula (I) in the polymer P₁ is ≥50% by weight, in particular ≥60% by weight, preferably ≥70% by weight, more preferably 280% by weight, even more preferably ≥90% by weight, yet more preferably ≥95% by weight, most preferably ≥99% by weight, based in each case on the molar weight of the polymer P₁.

In the process according to the invention, the mixture M₁ used in step (a) preferably comprises different polymers P₁. The individual polymers P₁ in this embodiment typically have different degrees of polymerization, i.e. n₁ is different for at least a portion of the polymers P₁ present in the mixture M₁ used in step (a).

In a further preferred embodiment of the present invention, the mixture M₁ used in step (a) comprises different polymers P₁, wherein at least 10%, preferably at least 20%, more preferably at least 30%, yet more preferably at least 50%, yet more preferably at least 75%, most preferably at least 99% of all of the polymers P₁ present in the mixture M₁ used in step (a) comprise at least one section A₁ composed of n₁≥100 interlinked repeating units of structural formula (I).

In a particularly preferred embodiment of the process according to the invention, the at least one polymer P₁ has the structural formula (I′) where

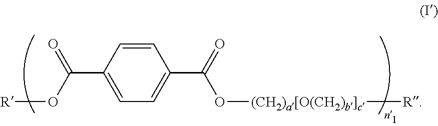

a′ is an integer where 2≤a′≤6, in particular a′=2 or 4, preferably a′=2.

b′ is an integer where 2≤b′≤6, in particular b′=2 or 4, preferably b′=2.

c′ is an integer where 0<c′≤10, in particular c′=0 or 1, preferably c′=0.

n′₁ is an integer ≥49, preferably ≥50.

A polymer P₁ having structural formula (I′) can also be represented as follows:

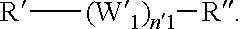

W′₁ thus corresponds to the structure encompassed by the set of brackets with the index “n′₁” in structural formula (I′). The unit W′₁ thus has the following structure:

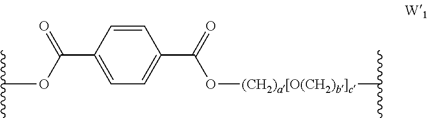

The n′₁ units W′₁ interlinked within the polymer P₁ according to structural formula (I′) are identical or different to one another, in particular identical, within the polymer P₁.

R′ is selected from —H, —(CH₂)a_{♥}—[O—(CH₂)b_{♥}]_{c♥}—OH.

a_{♥} is an integer where 2≤a_{♥}≤6, in particular a_{♥}=2 or 4, preferably a_{♥}=2.

b_{♥} is an integer where 2≤b_{♥}≤6, in particular b_{♥}=2 or 4, preferably b_{♥}=2.

c_{♥} is an integer where 0<c_{♥}≤10, in particular c_{♥}=0 or 1, preferably c_{♥}=0.

R″ is selected from the group consisting of —H, —OH, a radical of structural formula (IV) or (VII), preferably from the group consisting of —H, —OH, a radical of structural formula (IV), more preferably from the group consisting of —OH, a radical of structural formula (IV), wherein the structural formulae (IV) and (VII) are as follows:

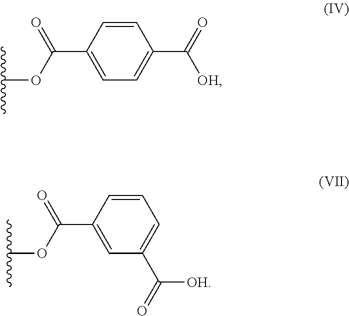

The process according to the invention is especially suitable for depolymerization of polyethylene terephthalate (“PET”) and polybutylene terephthalate (“PBT”). Thus, in a preferred embodiment, the polymer P₁ is selected from PET, PBT. The polymer P₁ is most preferably PET.

PBT corresponds to the polymer P₁ according to structural formula (I′) where a′=4, c′=0.

PET corresponds to the polymer P₁ according to structural formula (I′) where a′=2, c′=0.

In the process according to the invention, the mixture M₁ used in step (a) preferably comprises different polymers P₁ according to structural formula (I′). The individual polymers P₁ in this embodiment typically have different degrees of polymerization, i.e. n′1 is different for at least a portion of the polymers P₁ according to structural formula (I′) present in the mixture M₁ used in step (a).

In a further preferred embodiment of the present invention, the mixture M₁ used in step (a) comprises different polymers P₁ of structural formula (I′), wherein in at least 10%, preferably at least 20%, more preferably at least 30%, yet more preferably at least 50%, yet more preferably still at least 75%, most preferably at least 99% of all of the polymer molecules P₁ according to structural formula (I′) encompassed by the mixture M₁ used in step (a) n′₁≥99, yet more preferably n′₁≥100.

The at least one polymer P₁ which is encompassed by the mixture M₁ used in step (a) may be in solid or molten form, preferably in solid form, more preferably in particle form. The state of matter of the at least one polymer P₁ in the mixture M₁ used in step (a), and in the mixture M₁ during step (a), is dependent on the temperature Tₐ at which the mixture M₁ is used or at which step (a) of the process according to the invention is conducted.

### 1.2 Polyolefin PO

The mixture M₁ used in step (a), as well as the at least one polymer P₁, also comprises a melt of at least one polyolefin PO.

The polyolefin PO has a lower melting temperature T_{PO} than the melting temperature T_{P1} of the at least one polymer P₁ encompassed by the mixture M₁ used in step (a).

The at least one polyolefin PO is especially selected from the group consisting of polyethylene (“PE”; T_{PO}: 135° C.), polypropylene (“PP”; T_{PO}: 160° C.), polyisobutylene (“PIB”; T_{PO}: 54-56° C.), polybutylene (“PB”; T_{PO}: 135° C.).

The at least one polyolefin PO is preferably selected from the group consisting of PE, PP.

The at least one polyolefin PO is more preferably polyethylene PE.

In the embodiments in which the at least one polymer P₁ is PET (T_{P1}: 260° C.) or PBT (T_{P1}: 223° C.), especially PET, the polyolefin PO is especially selected from PE, PP, PIB, PB, preferably selected from PE, PP; more preferably, PO=PE.

The ratio of the weight of all polymers P₁ encompassed by the mixture M₁ used in step (a) to the weight of all polyolefins PO encompassed by the mixture M₁ used in step (a) is not subject to any further restriction and is especially in the range from 99:1 to 1:99, preferably in the range from 98:2 to 10:90, more preferably in the range from 97:3 to 25:75, even more preferably in the range from 96:4 to 50:50, even more preferably still in the range from 95:5 to 60:40, most preferably 95:5.

The temperature Tₐ at which step (a) of the process according to the invention is conducted is preferably at least 1° C. above the melting temperature T_{PO} of the polyolefin PO, especially at least 2° C., preferably at least 5° C., more preferably at least 10° C., even more preferably at least 50° C.

The temperature Tₐ is above the melting temperature T_{PO} of the polyolefin PO and may also be above or below, preferably below, the melting temperature T_{P1} of the at least one polymer P₁.

### 2. Step (a)

In step (a) of the process according to the invention, a first portion P_{G1} of at least one glycol compound G is added to the mixture M₁ used in step (a).

### 2.1 Glycol Compound G

The glycol compound G added as the first portion P_{G1} has the structural formula (V):

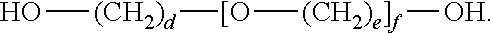

d is an integer where 2≤d≤6, in particular d=2 or 4, preferably d=2.

e is an integer where 2≤e≤6, in particular e=2 or 4, preferably e=2.

f is an integer where 0≤f≤10, in particular f=0 or 1, preferably f=0.

The glycol compound G added as the first portion P_{G1} is preferably selected from the group consisting of:
ethylene glycol (=ethane-1,2-diol; CAS-No.: 107-21-1; structural formula (V) with d=2, c=0);
butylene glycol (=butane-1,4-diol; CAS-No: 110-63-4; structural formula (V) with d=4, c=0);
diethylene glycol [=2-(2-hydroxyethoxy) ethanol; CAS-No.: 111-46-6; structural formula (V) with d=2, e=2, f=1];
   particular preference is given to ethylene glycol.

In a preferred embodiment of the present invention, the glycol compound G added as the first portion P_{G1} is that which is at least one of the products of the inventive depolymerization of the polymer P₁.

Thus the glycol compound G added as the first portion Poi is preferably ethylene glycol when the polymer P₁ at least in part has segments of polyethylene terephthalate PET, and yet more preferably when the polymer P₁ is PET.

Thus the glycol compound G added as the first portion P_{G1} is preferably butylene glycol when the polymer P₁ at least in part has segments of polybutylene terephthalate PBT, and yet more preferably when the polymer P₁ is PBT.

### 2.2 Reaction Conditions in Step (a)

In step (a) of the process according to the invention, a first portion P_{G1} of at least one glycol compound G is added to the mixture M₁. In the mixture M₁, there is then at least partial reaction of the glycol compound G with at least a portion of the polymers P₁ to give at least one cleavage product P₂, giving the mixture M₂ after step (a) has ended.

The reaction according to step (a) of the process according to the invention is performed in particular until the weight of all polymers P₁ in the mixture M₂ which is obtained after step (a) has ended has fallen by at least 10% by weight, preferably by at least 20% by weight, more preferably by at least 30% by weight, more preferably by at least 40% by weight, more preferably by at least 50% by weight, yet more preferably by at least 60% by weight, yet more preferably by at least 70% by weight, yet more preferably by at least 80% by weight, yet more preferably by at least 90% by weight, most preferably by at least 98% by weight, based in each case on the weight of all polymers P₁ in the mixture M₁ used in step (a).

It is preferable when the water content in the mixture M₁ during the reaction according to step (a) and in the mixture M₂ obtained after step (a) has ended is at a minimum, so that, in the reaction of the glycol compound G with the polymer P₁, the proportion of solvolytic transesterification is at a maximum and the proportion of hydrolytic ester cleavage is at a minimum. These two different reactions are shown in the following Scheme 1.

As is apparent from Scheme 1, the polymer P₁ [shown in the middle by a segment from structural formula (I′)], on reaction with the glycol compound G, undergoes solvolytic transesterification to give two cleavage products P₂ (bottom half of Scheme 1). The carboxylic acid groups of the termini of the two obtained cleavage products are esterified with G (last line of Scheme 1, cleavage product P₂, left-hand side) or with the alkylene glycol unit present in P₁ (last line of Scheme 1, cleavage product P₂, right-hand side). If the cleavage products P₂, or the compounds of structural formula (III) that have originated therefrom after conversion in step (c), are to be polymerized again to give a polymer P₁, these ester groups will enable easier conversion to the polymer P₁, and they are therefore advantageous cleavage products P₂.

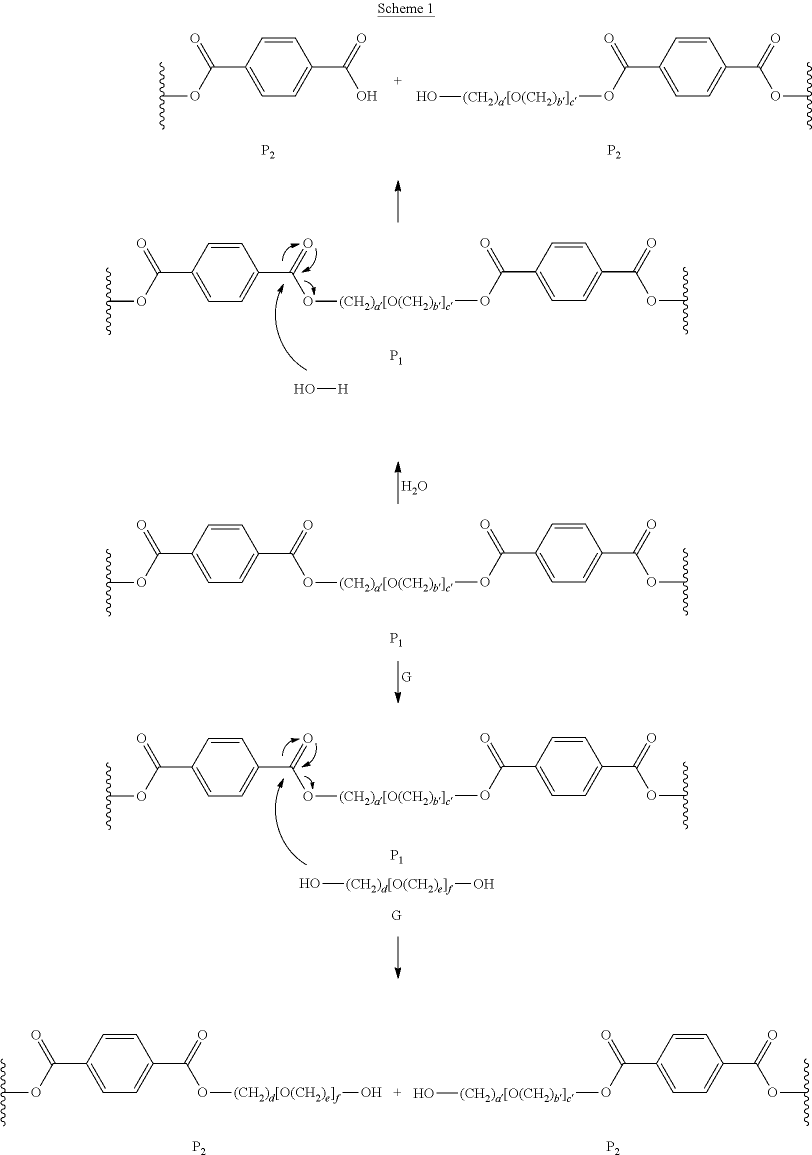

In the glycolysis of PET with ethylene glycol the desired diester bis(2-hydroxyethyl) terephthalic acid BHET is formed for example.

By contrast, the presence of water in the mixture M₁ during the reaction according to step (a) results in hydrolytic cleavage of the polymer P₁ and in the formation of disadvantageous cleavage products P₂.

This is shown in the top half of Scheme 1. This results in two cleavage products P₂, one of which bears a free, i.e. unesterified, carboxylic acid group at its terminus (first line of Scheme 1, cleavage product P₂, left-hand side). The conversion of such cleavage products P₂ to new polymers P₁ is costly and inconvenient and they are therefore disadvantageous. The hydrolysis of PET forms TS as the main product and also the monoester 2-hydroxyethyl terephthalate MHET.

It is therefore advantageous to keep the water content in the mixture M₁ as low as possible during the reaction according to step (a).

In a preferred embodiment of the present invention, the water content in the mixture M₁ during the reaction according to step (a) is therefore <10% by weight, more preferably <5% by weight, yet more preferably <1% by weight, yet more preferably <0.1% by weight, most preferably <0.01% by weight, based in each case on the total weight of the mixture M₁.

The proportion of the at least one glycol compound G added to the mixture M₁ as the first portion Pai is not subject to any further restriction. It is advantageous to cleave the polymer P₁ in step (a) to a maximum proportion of cleavage products P₂, and only then to convert these cleavage products P₂ further in step (c) to compounds of the structural formula (III). This is advantageously controlled via the amount of the at least one glycol compound G added as the first portion P_{G1} to the mixture M₁.

In a preferred embodiment of the process according to the invention, the molar amount of all glycol compounds G added to the mixture M₁ as the first portion P_{G1} in step (a) is ≥0.01 molar equivalent, and is more preferably in the range from 0.01 to 25 molar equivalents, even more preferably in the range from 0.01 to 5 molar equivalents, even more preferably in the range from 0.01 to 3 molar equivalents, even more preferably in the range from 0.01 to 1 molar equivalent, even more preferably in the range from 0.02 to 0.9 molar equivalents, even more preferably in the range from 0.03 to 0.8 molar equivalents, even more preferably in the range from 0.04 to 0.7 molar equivalents, yet more preferably in the range from 0.05 to 0.6 molar equivalents, yet more preferably in the range from 0.06 to 0.5 molar equivalents, yet more preferably in the range from 0.07 to 0.4 molar equivalents, yet more preferably in the range from 0.08 to 0.3 molar equivalents, yet more preferably in the range from 0.09 to 0.2 molar equivalents, most preferably in the range from 0.09 to 0.1 molar equivalents, based in each case on the molar amount of all repeating units of structural formula (I) encompassed by the polymers P₁ in the mixture M₁ used in step (a).

The process according to the invention is preferably performed solvolytically to minimize the proportion of undesired products (such as TS or MHET in the case of hydrolysis of PET) in the reaction product as far as possible and to maximize the proportion of desired products (such as BHET in the case of solvolysis of PET with ethylene glycol) in the reaction product.

It is therefore preferable when the water content of the first portion Poi of the at least one glycol compound G added in step (a), based on the total weight of all glycol compounds G added as the first portion P_{G1} in step (a), is <10% by weight, more preferably <5% by weight, even more preferably <1% by weight, yet more preferably <0.1% by weight, most preferably <0.01% by weight.

Step (a) is conducted at a temperature Tₐ which is above the melting temperature T_{PO} of the at least one polyolefin PO encompassed by the mixture M₁ used in step (a). As a result, the polyolefin PO during step (a) is in form of a melt, in which the reaction according to step (a) can be conducted advantageously. The polyolefin PO is inert under the reaction conditions in step (a) or step (c) in the mixture M₁ or in the mixture M₃, i.e. it essentially does not react with the glycol compound G. The temperature Tₐ may also be selected such that it is below or above the melting temperature T_{P1} of the at least one polymer P₁ during step (a). The temperature Tₐ during step (a) is preferably chosen such that, at the start of step (a), it is above T_{P1} on commencement of the addition of G, and falls to a value below T_{P1} (but of course above T_{PO}) during the reaction in step (a).

If the temperature Tₐ is below the melting temperature T_{P1} of the at least one polymer P₁, this accordingly means that Tₐ is between the melting temperature T_{PO} of the polyolefin PO and the melting temperature T_{P1} of the at least one polymer P₁. The at least one polymer P₁ is then at least partly, preferably completely, in the solid state of matter in the mixture M₁.

If the temperature Tₐ is above the melting temperature T_{P1} of the at least one polymer P₁, this accordingly means that Tₐ is both above the melting temperature T_{PO} of the polyolefin PO and above the melting temperature T_{P1} of the at least one polymer P₁. Both the at least one polymer P₁ and polyolefin PO are then in the form of a melt in mixture M₁.

When the at least one polymer P₁ is selected from PBT and PET, the temperature Tₐ is preferably in the range from 165° C. to 270° C., more preferably in the range from 170° C. to 265° C., yet more preferably in the range from 180° C. to 220° C., most preferably in the range from 190° C. to 210° C. This is advantageous especially when the polyolefin PO is selected from polyethylene (“PE”; T_{PO}: 135° C.), polypropylene (“PP”; T_{PO}: 160° C.), polyisobutylene (“PIB”; T_{PO}: 54-56° C.), polybutylene (“PB”; T_{PO}: 135° C.), more preferably when the polyolefin PO is selected from PE, PP.

When PO=PE and the at least one polymer P₁ is selected from PBT and PET, preferably P₁=PET; in another embodiment, the temperature Tₐ is preferably within a range from 140° C. to 270° C., more preferably within a range from 165° C. to 270° C., more preferably in the range from 170° C. to 265° C., yet more preferably in the range from 180° C. to 220° C., most preferably in the range from 190° C. to 210° C.

Step (a) of the process according to the invention is preferably conducted at least partly in a kneader or extruder E, preferably in an extruder E.

Extruders are familiar to the skilled person and described for various chemical reactions and processes, for example in WO 2020/053051 A1 and EP 2 455 424 A1. An extruder is generally understood to mean a machine which accommodates solid to liquid molding compounds, typically in an interior of the extruder, and extrudes these out of a product outlet (or “opening”) which is in particular a die, predominantly continuously (according to DIN 24450:1987-02); see Somborn R, Extruder, RD-05-02432 (2004) in Böckler F., Dill B., Eisenbrand G., Faupel F., Fugmann B., Gamse T., Matissek R., Pohnert G., Ruhling A., Schmidt S., Sprenger G., ROMPP [Online], Stuttgart, Georg Thieme Verlag, [December 2022]; retrievable online at https://roempp.thieme.de/lexicon/RD-05-02432, last retrieved 22 Dec. 2022.

Extruders E used in a preferred embodiment are piston extruders or multi-shaft extruders, particular preference being given to multi-shaft extruders.

Preferred multi-shaft extruders are planetary roll extruders or multi-screw extruders. Multi-screw extruders are especially twin-screw extruders.

### 2.3 Cleavage Product P₂

In step (a) of the process according to the invention, at least a portion of the polymers P₁ in the mixture M₁ is reacted at least partly with the glycol compound G to give at least one cleavage product P₂. The cleavage product P₂ has the structural formula (II):

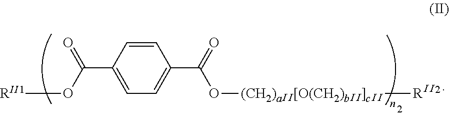

a^{II} is an integer where 2≤a^{II}≤6, in particular a^{II}=2 or 4, preferably a^{II}=2.

b^{II} is an integer where 2≤b^{II}≤6, in particular b^{II}=2 or 4, preferably b^{II}=2.

c^{II} is an integer where 0≤c^{II}≤10, in particular c^{II}=0 or 1, preferably c^{II}=0.

n₂ is an integer where 2≤n₂≤48.

Structural formula (II) can also be expressed as “R^{II1}—(W₂)ₙ₂—R^{II2}”. W₂ thus corresponds to the structure encompassed by the set of brackets with the index “n₂” in structural formula (II):

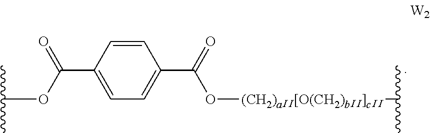

The n₂ repeating units W₂ interlinked within the cleavage product P₂ may be the same or different within the cleavage product P₂. This means that a molecule P₂ may have groups W₂ that are the same or different (i.e. have different values of a^{II}, b^{II} and/or c^{II} for example).

R^{II1} is selected from the group consisting of —H, —(CH₂)a_{♥}—[O—(CH₂)_{b♥}]_{c♥}—OH.

a_{♥} is an integer where 2≤a_{♥}≤6, in particular a_{♥}=2 or 4, preferably a_{♥}=2.

b_{♥} is an integer where 2≤b_{♥}≤6, in particular b_{♥}=2 or 4, preferably b_{♥}=2.

c_{♥} is an integer where 0≤c_{♥}≤10, in particular c_{♥}=0 or 1, preferably c_{♥}=0.

R^{II2} is selected from the group consisting of —H, —OH, a radical of structural formula (IV), preferably from the group consisting of —OH, a radical of structural formula (IV), wherein structural formula (IV) is as follows:

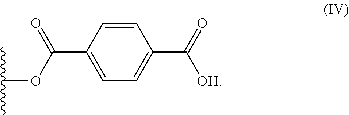

The cleavage products P₂ of structural formula (II) where a^{II}=2; c^{II}=0; a_{♥}=2; c_{♥}=0 are also referred to in accordance with the invention as “BHET oligomers” or “oligomers of BHET”.

The molar amount of cleavage product P₂ and of polymer P₁ in a given mixture, in particular in one of the mixtures M₁, M₂, M₃ and M₄, can be determined by test methods known to those skilled in the art. According to the invention, the molecular weight distributions of the polymers P₁ and the cleavage products P₂ (and thus the average degree of polymerization ρ) are determined by gel permeation chromatography (“GPC”) according to Method 1 (see Examples). This method is likewise used in accordance with the invention to determine the distribution of the average degree of polymerization ρ over all polymers P₁ or over all cleavage products P₂ in a given mixture, especially in one of mixtures M₁, M₂, M₃ and M₄.

The content of compounds (III) in a given mixture, in particular in one of mixtures M₁, M₂, M₃ and M₄, can be determined by test methods known to those skilled in the art, preferably via nuclear magnetic resonance (“NMR”) or chromatography.

Accordingly, what is obtained after step (a) has ended is a mixture M₂ comprising at least one cleavage product P₂ and a melt of the at least one polyolefin PO.

### 2.4 Catalyst K₁

It is advantageous that the reaction of the glycol compound G with the polymer P₁ in the mixture M₁ in step (a) is performed in the presence of at least one catalyst K₁.

The catalyst K₁ may already be present in the mixture M₁ prior to addition of the at least one glycol compound G, be added to the mixture M₁ after addition of the at least one glycol compound G, and/or be added to the mixture M₁ together with the at least one glycol compound G.

The catalyst K₁ may be selected by a person skilled in the art according to their knowledge in the art.

The catalyst K₁ is preferably selected from the group consisting of carbonates, hydrogencarbonates, metal halides, amines, alkoxides, acetates, phosphates, dibutyltin oxide, more preferably from the group consisting of amines, alkoxides, acetates; yet more preferably, the catalyst K₁ is an alkoxide, yet more preferably an alkali metal alkoxide.

A preferred acetate is selected from the group consisting of lead acetate, zinc acetate, wherein zinc acetate is more preferred.

Preferred phosphates are alkali metal phosphates, in particular sodium phosphate.

A preferred metal halide is zinc chloride.

Preferred carbonates are alkali metal carbonates or alkaline earth metal carbonates, in particular alkali metal carbonates, preferably sodium carbonate.

Preferred hydrogencarbonates are alkali metal hydrogencarbonates or alkaline earth metal hydrogencarbonates, in particular alkali metal hydrogencarbonates, preferably sodium hydrogencarbonate.

Amines used are preferably trialkylamines, for example trimethylamine, triethylamine, dimethylethylamine, di(iso-propyl)ethylamine (“DIPEA”) or cyclic amines such as, in particular, 1,5,7-triazabicyclo[4.4.0]dec-5-ene (“TBD”) or 1,8-diazabicyclo[5.4.0]undec-7-ene (“DBU”). These have the following structural formulae:

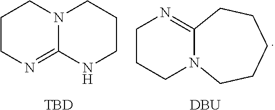

TBD is described in K. Fukushima, O. Coulembier, J. M. Lecuyer, H. A. Almegren, A. M. Alabdulrahman, F. D. Alsewailem, M. A. McNeil, P. Dubois, R. M. Waymouth, H. W. Horn, J. E. Rice, J. L. Hedrick, Journal of Polymer Science Part A: Polymer Chemistry 2011, 49, 1273-1281.

Trialkylamines, DBU and TBD were presented in this context at the conference “Polyester Digestion: VOLCAT. Summit on Realizing the Circular Carbon Economy” on 24 Jul. 2018 by B. Allen, G. Breyta, J. Garcia, G. Jones, J. Hedrick in San Jose, California, USA (slides retrievable at https://www.energy.gov/sites/prod/files/2018/10/f56/Robert_Allen_CCE_PanelDayl_0.pdf; last retrieved 15 Jan. 2023).

If the catalyst K₁ used is an alkoxide, in particular an alkali metal alkoxide, it is preferably used in solid form, for example in the form of a powder or granules.

Preferred alkoxides are alkali metal alkoxides, wherein the alcohol is a monohydric or dihydric alcohol having 1 to 6 carbon atoms

Yet more preferred alkali metal alkoxides are those wherein the alkoxide is selected from the group consisting of methoxide;
ethoxide;
propoxide, meaning n-propoxide or iso-propoxide;
butoxide, in particular n-butoxide;
pentoxide, in particular n-pentoxide;
hexoxide, in particular n-hexoxide;
ethyleneglycolate;
   more preferably selected from methoxide, ethoxide, ethyleneglycolate, yet more preferably selected from methoxide, ethoxide and most preferably selected from methoxide.

In the context of the invention “ethyleneglycolate” is understood to mean the corresponding salt of ethylene glycol. According to the invention, the term “M_{A}-ethyleneglycolate”, where M_{A} is an alkali metal, includes at least one of M_{A}O—CH₂—CH₂—OH and MAO-CH₂—CH₂-OM_{A},
preferably at least M_{A}O—CH₂—CH₂—OH,
most preferably M_{A}O—CH₂—CH₂—OH and M_{A}O—CH₂—CH₂-OM_{A}.

Preferred alkali metals here are lithium, sodium, potassium, more preferably sodium, potassium, yet more preferably sodium.

In a particularly preferred embodiment, the catalyst K₁ is selected from the group consisting of sodium ethyleneglycolate, potassium ethyleneglycolate, potassium methoxide, sodium methoxide, potassium ethoxide, sodium ethoxide, more preferably selected from the group consisting of potassium methoxide, sodium methoxide, potassium ethoxide, sodium ethoxide, yet more preferably selected from the group consisting of sodium methoxide, potassium ethoxide, sodium ethoxide; particularly preferably, K₁=sodium methoxide.

The alkali metal alkoxides usable as catalysts K₁ and K₂ in the process according to the invention may be prepared according to the knowledge of a person skilled in the art, for example by reactive distillation from the corresponding alcohol and the corresponding alkali metal hydroxide, as described, for example, in EP 1 997 794 A1, WO 01/42178 A1, WO 2021/148174 A1, WO 2021/148175 A1, WO 2022/117803 A1, WO 2022/167311 A1, WO 2022/263032 A1, EP 4 074 684 A1, EP 4 074 685 A1.

The alkali metal alkoxides usable as catalysts K₁ and K₂ in the process according to the invention may alternatively also be prepared by transalcoholization from the corresponding alcohol and another alkoxide. A corresponding preparation of alkali metal alkoxides is described, for example, by CS 213 119 B1, GB 490,388 A, DE 689 03 186 T2 and EP 0 776 995 A1.

Transalcoholizations by reactive distillation, which likewise afford alkoxides, in particular alkali metal alkoxides, that can be used in the process according to the invention as catalyst K₁ (or else as catalyst K₂) are described in WO 2021/122702 A1, DE 27 26 491 A1, DE 1 254 612 B.

The alkoxides usable in accordance with the invention as catalysts K₁ and K₂ may also be prepared electrochemically, as described, for example, in EP 3 885 470 A1, EP 3 885 471 A1, EP 4 043 616 A1, EP 4 112 778 A1, WO 2023/274796 A1, WO 2023/274794 A1.

The amount of the catalyst K₁ used in step (a) may be chosen by a person skilled in the art according to their knowledge in the art. The molar amount of all catalysts K₁ used in step (a), based on the molar amount of all glycol compounds G added as the first portion Poi in step (a), is in particular in the range from 0.01% to 10%, preferably in the range from 0.1 to 5%, more preferably in the range from 1% to 4%, yet more preferably in the range from 2.5% to 3.5%, especially preferably 3%.

### 2.5 Mixture M₂

After step (a) of the process according to the invention has ended, a mixture M₂ is obtained. This comprises the at least one cleavage product P₂ and a melt of the at least one polyolefin PO. Since the mixture M₂ comprises a melt of the at least one polyolefin PO, the mixture M₂ will be at a temperature above the melting temperature T_{PO} of the polyolefin PO. The exact temperature at which the mixture M₂ is obtained after step (a) has ended may, but need not, be that temperature Tₐ at which the reaction in step (a) took place. All that is essential to the invention is that the mixture M₂ is at a temperature above the melting temperature T_{PO} of the polyolefin PO. In a preferred embodiment, the mixture M₂ after step (a) has ended is at the temperature Tₐ at which the reaction in step (a) was conducted.

The mixture M₂ may also comprise at least one polymer P₁. This is the case, for example, when not all polymers P₁ encompassed by the mixture M₁ used in step (a) of the process according to the invention have been reacted with a glycol compound G, especially when the glycol compound G has been used in step (a) in molar deficiency based on the repeating units of structural formula (I) encompassed by the polymers P₁ in the mixture M₁ used in step (a).

The mixture M₂ may also comprise at least one compound of structural formula (III). This is the case, for example, when the at least one polymer P₁ reacts with the at least one glycol compound G in the reaction in step (a) to give a cleavage product P₂ and a compound of the structural formula (III).

The mixture M₂ may also comprise at least one glycol compound G.

It is at least the case that the molar amount of all cleavage products P₂ in the mixture M₂ after step (a) has ended is greater than the molar amount of all cleavage products P₂ in the mixture M₁ used in step (a). This is true irrespective of whether or not the mixture M₁ used in step (a) comprises cleavage products P₂.

This is merely because, in step (a) of the process according to the invention, at least a portion of the polymers P₁ in the mixture M₁ is reacted with the at least one glycol compound G to give at least one cleavage product P₂. By means of suitable reaction conditions (for example the amount of the glycol compound G added as the first portion P_{G1} or the reaction time), the person skilled in the art can also set conditions so as to obtain a maximum amount of cleavage products P₂ in M₂, for example by preventing the further reaction P₂ with G to give a compound of the structural formula (III) in step (a). This further reaction preferably takes place essentially only in step (c).

In a preferred embodiment of the present invention, the ratio of the molar amount of all cleavage products P₂ of the structural formula (II) in the mixture M₁ used in step (a) to the molar amount of all polymers P₁ in the mixture M₁ used in step (a) is thus <1:99 [which also includes the case of absence of cleavage products P₂ of the structural formula (II) in the mixture M₁ used in step (a)], and the ratio of all cleavage products P₂ of structural formula (II) in the mixture M₂, in the case of addition of the second portion P_{G2} of the at least one glycol compound G in step (b), to the molar amount of all polymers P₁ in the mixture M₂, on addition of the second portion P_{G2} of the at least one glycol compound G in step (b), is ≥1:99, preferably ≥1:9, more preferably ≥1:4, more preferably ≥2:3, more preferably ≥1:1, more preferably >3:2, more preferably ≥4:1, more preferably ≥9:1, more preferably ≥99:1 (which in each case also includes the absence of polymers P₁ in mixture M₂).

In a further preferred embodiment of the present invention, the ratio of the molar amount of all cleavage products P₂ of the structural formula (II) in the mixture M₁ used in step (a) to the molar amount of all polymers P₁ in the mixture M₁ used in step (a) is <1:9 [which also includes the case of absence of cleavage products P₂ of the structural formula (II) in the mixture M₁ used in step (a)], and the ratio of all cleavage products P₂ of structural formula (II) in the mixture M₂, in the case of addition of the second portion P_{G2} of the at least one glycol compound G in step (b), to the molar amount of all polymers P₁ in the mixture M₂, on addition of the second portion P_{G2} of the at least one glycol compound G in step (b), is ≥1:9, more preferably ≥1:4, more preferably ≥2:3, more preferably ≥1:1, more preferably ≥3:2, more preferably >4:1, more preferably ≥9:1, more preferably ≥99:1 (which in each case also includes the absence of polymers P₁ in mixture M₂).

In a further preferred embodiment of the present invention, the ratio of the molar amount of all cleavage products P₂ of the structural formula (II) in the mixture M₁ used in step (a) to the molar amount of all polymers P₁ in the mixture M₁ used in step (a) is <1:4 [which also includes the case of absence of cleavage products P₂ of the structural formula (II) in the mixture M₁ used in step (a)], and the ratio of all cleavage products P₂ of structural formula (II) in the mixture M₂, in the case of addition of the second portion P_{G2} of the at least one glycol compound G in step (b), to the molar amount of all polymers P₁ in the mixture M₂, on addition of the second portion P_{G2} of the at least one glycol compound G in step (b), is ≥1:4, more preferably ≥2:3, more preferably ≥1:1, more preferably ≥3:2, more preferably ≥4:1, more preferably ≥9:1, more preferably ≥99:1 (which in each case also includes the absence of polymers P₁ in mixture M₂).

In a further preferred embodiment of the present invention, the ratio of the molar amount of all cleavage products P₂ of the structural formula (II) in the mixture M₁ used in step (a) to the molar amount of all polymers P₁ in the mixture M₁ used in step (a) is <2:3 [which also includes the case of absence of cleavage products P₂ of the structural formula (II) in the mixture M₁ used in step (a)], and the ratio of all cleavage products P₂ of structural formula (II) in the mixture M₂, in the case of addition of the second portion P_{G2} of the at least one glycol compound G in step (b), to the molar amount of all polymers P₁ in the mixture M₂, on addition of the second portion P_{G2} of the at least one glycol compound G in step (b), is ≥2:3, more preferably ≥1:1, more preferably ≥3:2, more preferably ≥4:1, more preferably ≥9:1, more preferably ≥99:1 (which in each case also includes the absence of polymers P₁ in mixture M₂).

In a further preferred embodiment of the present invention, the ratio of the molar amount of all cleavage products P₂ of the structural formula (II) in the mixture M₁ used in step (a) to the molar amount of all polymers P₁ in the mixture M₁ used in step (a) is <1:1 [which also includes the case of absence of cleavage products P₂ of the structural formula (II) in the mixture M₁ used in step (a)], and the ratio of all cleavage products P₂ of structural formula (II) in the mixture M₂, in the case of addition of the second portion P_{G2} of the at least one glycol compound G in step (b), to the molar amount of all polymers P₁ in the mixture M₂, on addition of the second portion P_{G2} of the at least one glycol compound G in step (b), is ≥1:1, more preferably ≥3:2, more preferably ≥4:1, more preferably ≥9:1, more preferably ≥99:1 (which in each case also includes the absence of polymers P₁ in mixture M₂).

In a further preferred embodiment of the present invention, the mixture M₂, on addition of the second portion P_{G2} of the at least one glycol compound G in step (b), comprises a mixture of cleavage products P₂. The average degree of polymerization ρ of all polymer molecules P₂ encompassed by the mixture M₂, on addition of the second portion P_{G2} of the at least one glycol compound G in step (b), is in the range from 2 to 30, more preferably 3 to 20, even more preferably 4 to 10.

In the optional embodiment of the invention in which the mixture M₂ obtained after step (a) has ended also comprises at least one polymer P₁, it is preferable when at least one of the following two conditions (α*), (β*) are met, more preferably at least condition (β*) is met, and preferably both conditions (α*) and (β*) are met:
(α*) the average degree of polymerization ρ₁₂ of all polymers P₁ encompassed by mixture M₂ on addition of the second portion P_{G2} of the at least one glycol compound G in step (b) is lower than the average degree of polymerization ρ₁₁ of all polymers P₁ encompassed by the mixture M₁ used in step (a);
(β*) the molar amount of all polymers P₁ encompassed by the mixture M₂ on addition of the second portion P_{G2} of the at least one glycol compound G in step (b) is smaller than the molar amount of all polymers P₁ encompassed by the mixture M₁ used in step (a).

### 2.6 Degree of Polymerization π, Average Degree of Polymerization ρ

The term “degree of polymerization π” in the context of the invention refers to a single molecule of a polymer P₁ or a single molecule of the cleavage product P₂.

In the case of polymer P₁, the degree of polymerization π gives the number of repeat units of the structural formula W₃ below within the molecule P₁ in question, where the repeat units of the structural formula W₃ are joined to one another such that the bond identified by “($)” of one repeat unit of the structural formula W₃ is joined to the bond identified by “($$)” in the adjacent repeat unit of the structural formula W₃.

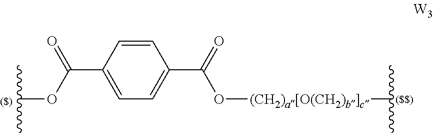

a″ here is an integer for which 2≤a″≤6.

b″ here is an integer for which 2≤b″≤6.

c″ here is an integer for which 0≤c″≤10.

In other words: in order to ascertain the degree of polymerization π of a polymer molecule P₁ according to the invention, in the polymer molecule P₁ in question, all repeat units of the structural formula W₃ in the sections in which at least two repeat units of the structural formula (I) are interlinked are counted up. The sum total of the repeat units W₃ encompassed by all sections then gives the degree of polymerization π of the polymer molecule P₁.

In the preferred embodiment in which the polymer P₁ has structural formula (I′), the degree of polymerization π gives the number of repeat units of the structural formula W₃ within the polymer P₁.

In the case of the cleavage product P₂, the degree of polymerization π indicates the number of repeat units of the structural formula W₃ within the cleavage product P₂.

The “average degree of polymerization ρ” relates to the polymer molecules P₁ encompassed by a composition, for example of the respective mixture M₁, M₂, M₃ or M₄, or to all cleavage products P₂ encompassed by a composition, for example of the respective mixture M₁, M₂, M₃ or M₄. The size distribution of the polymers P₁ or cleavage products P₂, from which the average degree of polymerization ρ can be calculated, is determined in accordance with the invention by Method 1 which is described in the Examples.

The average degree of polymerization ρ₁ over all polymer molecules P₁ in a given mixture M_{X} is the quotient [Σ(π_{P1})]/n_{P1} where “Σ(πP₁)” is the sum total of the degrees of polymerization π of all polymer molecules P₁ in the mixture M_{X} and n_{P1} is the molar amount of all polymer molecules P₁ encompassed by M_{X}.

The average degree of polymerization ρ₂ over all cleavage products P₂ in a given mixture M_{X} is the quotient [Σ(π_{P2})]/n_{P2} where “Σ(π_{P2})” is the sum total of the degrees of polymerization π of all cleavage product molecules P₂ in the mixture M_{X} and n_{P2} is the molar amount of all cleavage product molecules P₂ encompassed by M_{X}.

### 3. Step (b)

In step (b) of the process according to the invention, the mixture M₂ obtained after step (a) has ended is cooled to a temperature T_{b} below the melting temperature of the at least one polyolefin PO,
wherein, during and/or after the cooling of the mixture M₂ to the temperature T_{b}, a second portion P_{G2} of at least one glycol compound G of the structural formula (V) is added to the mixture M₂.

After step (b) has ended, this affords a mixture M₃ comprising
at least one cleavage product P₂,
the at least one polyolefin PO in the solid state,
at least one glycol compound G,
optionally at least one polymer P₁.

This mixture M₃ obtained after step (b) has ended is then converted further in step (c). It has been found that, surprisingly, the second reaction [in step (c)] in the process according to the invention, in which the cleavage products P₂ are converted to compounds of structural formula (III), is advantageously conducted in a reaction mixture in which the polyolefin PO is in the solid state. This means that step (c) is conducted in accordance with the invention at a temperature T_{c} below the melting temperature T_{PO} of the polyolefin PO. The temperature T_{c} here may be the same as the temperature T_{b}, but may also be higher or lower, provided that T_{c} is below the melting temperature of PO.

The solid polyolefin PO can then be more easily and efficiently separated from the mixture M₄ obtained after step (c) has ended than in comparative processes in which the at least one polymer P₁ is converted to a compound of structural formula (III) using one or else two portions of at least one glycol compound G added consecutively to the reaction mixture at a temperature >T_{PO} throughout, i.e. in a reaction mixture in which PO is in molten form throughout, and the reaction mixture is lowered to a temperature below the melting temperature of PO only after the reaction has ended. These non-inventive conditions result in a crude product in which the polyolefin PO is in solid form, but in the form of a viscous agglomerate that can be separated only with difficulty from the other desired constituents of the crude product, for example compounds of structural formula (III), and from the apparatus itself.

The process according to the invention is advantageously controlled here such that step (a) essentially comprises reacting the polymers P₁ encompassed by the mixture M₁ used in step (a) with the at least one glycol compound G added as the first portion P_{G1} to give the cleavage product P₂, and then step (c) comprises essentially reacting the cleavage product P₂ present in mixture M₃ with the at least one glycol compound G added as the second portion P_{G2} in step (b) to give at least one compound of structural formula (III). This division of the co-reactants of the respectively added glycol compound G may be controlled by the person skilled in the art in the context of the invention, for example, via the amount of the at least one glycol compound G added as the first portion P_{G1} or second portion P_{G2} (based on the repeat units of the formula W₃ encompassed by all polymers P₁ in M₁ or all cleavage products P₂ in M₂) or else via the reaction time in step (a).

It is thus advantageous and preferable to control the process according to the invention in such a way that the reaction of the cleavage product P₂ with the at least one glycol compound G essentially does not take place until step (c) in the presence of solid PO. This can be controlled, for example, by adding the second portion P_{G2} of the at least one glycol compound G to the mixture M₂ in step (b) only after the mixture M₂ has gone below the melting temperature T_{PO} of the polyolefin PO during the cooling to temperature T_{b}.

Mixture M₂, as elucidated above, after step (a) of the process according to the invention has ended, is obtained at a temperature above the melting temperature T_{PO}. In step (b), M₂ is cooled to a temperature T_{b} below the melting temperature of the polyolefin PO. It will thus be apparent that mixture M₂ during step (b) will have the melting point T_{PO} of the polyolefin PO at one point (and will then go below it).

“Cooling the mixture M₂ to the temperature T_{b} below the melting temperature T_{PO} of the at least one polyolefin PO” in the context of the invention also includes the embodiment in which the mixture M₂ is first cooled to a temperature T_{b*}<T_{b} and then warmed from T_{b*} to T_{b}.

The temperature of mixture M₃ after step (b) of the process according to the invention has ended is below the melting temperature T_{PO} (since this is the prerequisite for the at least one polyolefin PO being in the solid state) and may be equal to or different from temperature T_{b}.

The second portion P_{G2} of the at least one glycol compound G is added to the mixture M₂ in step (b) during and/or after the cooling of the mixture M₂ to the temperature T_{b}.

In particular, the second portion P_{G2} of the at least one glycol compound G is added to the mixture M₂ in step (b) after the mixture M₂ has been cooled to the temperature T_{b}. This is the most advantageous way of assuring that the reaction in step (c) is conducted completely in a mixture M₂ in which the at least one polyolefin PO is in the solid state.

“Cooling the mixture M₂ to a temperature T_{b} below the melting temperature T_{PO} of the at least one polyolefin PO while a second portion P_{G2} of at least one glycol compound G is added to mixture M₂ during the cooling of mixture M₂ to the temperature T_{b}” (abbreviated as “embodiment Ω”) encompasses the following embodiments/options i., ii.:
i. the second portion P_{G2} of the at least one glycol compound G is added completely to mixture M₂ during the cooling of mixture M₂ to temperature T_{b}, provided that the temperature of mixture M₂ is higher than the melting temperature T_{PO} of the polyolefin PO;
ii. part of the second portion P_{G2} of the at least one glycol compound G (=option ii.-A), or the whole second portion P_{G2} of the at least one glycol compound G (=option ii.-B), is added to mixture M₂ during the cooling of mixture M₂ to the temperature T_{b}, provided that mixture M₂ is at a temperature below the melting temperature T_{PO} of the at least one polyolefin PO.

Option ii. is more preferred than option i., since option ii. assures more complete conversion of the entirety of the at least one glycol compound G added as portion P_{G2} in step (c), i.e. completely in a mixture in which the polyolefin PO is in solid form.

Within option (ii), option (ii-B) is preferred over option (ii-A) for the same reason.

Option i. of embodiment “Ω” and option ii-A are conducted with preference when the mixture M₂ used in step (b) still has a relatively high proportion of polymer P₁ unconverted in step (a), preferably when ψ≥40%, more preferably when ψ≥50%, yet more preferably when ψ≥60%, yet more preferably when ψ≥70%, yet more preferably when ψ≥80%. ψ in all these embodiments is <1, since there would otherwise be no conversion in step (a).

ψ denotes the quotient of the molar amount of all polymers P₁ in the mixture M₂ on addition of the second portion P_{G2} of the at least one glycol compound G in step (b) to the molar amount of all polymers P₁ in the mixture M₁ used in step (a).

This preferred embodiment in which the addition of at least part of the second portion P_{G2} of the at least one glycol compound G to mixture M₂ is undertaken before M₂ goes below the melting temperature T_{PO} is advantageous particularly when a considerable residual proportion of polymer P₁ is still encompassed by mixture M₂.

In embodiment Ω, option ii.-A, the ratio of the molar amount of all glycol compounds G which is added to M₂ as part of the second portion P_{G2}, provided that the temperature of mixture M₂ is higher than T_{PO}, to the molar amount of glycol compounds G which is added to M₂ as part of the second portion P_{G2}, provided that the temperature of mixture M₂ is lower than T_{PO}, is in the range from 99:1 to 1:99, especially in the range from 9:1 to 1:99, preferably in the range from 4:1 to 1:99, more preferably in the range from 3:2 to 1:99, yet more preferably in the range from 1:1 to 1:99, yet more preferably still in the range from 2:3 to 1:99, yet more preferably still in the range from 1:4 to 1:99, yet more preferably still in the range from 1:90 to 1:99.

After step (b) has ended, mixture M₃ is then obtained.

For the reasons described above, it is advisable to undertake the reaction of the cleavage products P₂ with the at least one glycol compound G only when the temperature of mixture M₂ has gone below the melting temperature of the at least one polyolefin T_{PO} on cooling to temperature T_{b}.

In the case of option i. and in the case of option ii-A of embodiment “Ω”, it is therefore preferable to control the process according to the invention such that χ≥40%, more preferably χ≥50%, yet more preferably χ≥60%, yet more preferably still χ≥75%, even more preferably again χ≥85%, most preferably χ≥90%.

χ is the quotient (n_{Z1}/n_{Z2}).

n_{Z1} here is the molar amount of all cleavage products P₂ encompassed by mixture M₂ at the time (“time Z1”) when the temperature of mixture M₂ is equal to the melting temperature T_{PO} of the polyolefin PO on cooling to T_{b}.

n_{Z2} here is the molar amount of all cleavage products P₂ encompassed by mixture M₂ on addition of the second portion P_{G2} of the at least one glycol compound G in step (b) (“time Z2”).

It will be apparent that time Z2 is before Z1 in options i. and ii-A. of embodiment “Ω”.

In this preferred embodiment, it is ensured that, in options i. and ii-A. of embodiment “Ω”, there will first have been reaction of a very small proportion of the cleavage products P₂ with the glycol compound G added as the second portion P_{G2} before the temperature goes below the melting temperature T_{PO} of the polyolefin PO in step (b).

In a further preferred embodiment, the proportion of the molar amount of all cleavage products P₂ encompassed by mixture M₂ that have not more than 20 repeating units of structural formula W₃ based on the molar amount of all cleavage products P₂ encompassed by mixture M₂ on addition of the second portion P_{G2} of the at least one glycol compound G in step (b) is at least 25%, preferably at least 40%, more preferably at least 50%, yet more preferably at least 70%, yet more preferably at least 85%.

The glycol compound G added as the second portion P_{G2} has the aforementioned structural formula (V)

It is preferable that the glycol compound G added as the first portion P_{G1} and the glycol compound G added as the second portion P_{G2} are the same, are more preferably both selected from the group consisting of ethylene glycol, butylene glycol, diethylene glycol, and are even more preferably both selected from the group consisting of ethylene glycol, butylene glycol. Most preferably, the glycol compound G added as the first portion P_{G1} and added as the second portion P_{G2} is ethylene glycol.

In a preferred embodiment of the process according to the invention, the molar amount of all glycol compounds G added to the mixture M₂ as the second portion P_{G2} in step (b) is ≥0.01 molar equivalent, more preferably ≥0.1 molar equivalent, and is more preferably in the range from 0.1 to 25 molar equivalents, more preferably in the range from 0.2 to 10 molar equivalents, more preferably in the range from 0.3 to 8 molar equivalents, even more preferably in the range from 0.4 to 7 molar equivalents, yet more preferably in the range from 0.5 to 6 molar equivalents, yet more preferably in the range from 0.6 to 5 molar equivalents, yet more preferably in the range from 0.7 to 4 molar equivalents, yet more preferably in the range from 0.8 to 3 molar equivalents, yet more preferably in the range from 0.9 to 2 molar equivalents, most preferably in the range from 1 to 1.5 molar equivalents, based in each case on the molar amount of all repeating units of structural formula (I) encompassed by the polymers P₁ and the cleavage products P₂ in the mixture M₁ used in step (a).

In a preferred embodiment, the at least one glycol compound G serves as solvent for compound (III) in the mixture M₄ obtained after step (c).

The process according to the invention is preferably performed solvolytically to minimize the proportion of undesired products (such as TS or MHET in the case of hydrolysis of PET) in the reaction product as far as possible and to maximize the proportion of desired products (such as BHET in the case of solvolysis of PET with ethylene glycol) in the reaction product.

It is therefore preferable when the water content of the second portion P_{G2} of the at least one glycol compound G added in step (b), based on the total weight of all glycol compounds G added in step (b), is <10% by weight, more preferably <5% by weight, yet more preferably <1% by weight, yet more preferably <0.1% by weight, most preferably <0.01% by weight.

After step (b) has ended, the mixture M₃ is obtained at a temperature below the melting temperature T_{PO} of the polyolefin PO. This ensures that the polyolefin PO is used in solid form in step (c).

When the polyolefin PO is selected from PE and PP, the temperature T_{b} is preferably within a range from 80° C. to 134° C., more preferably in the range from 90° C. to 130° C., yet more preferably in the range from 100° C. to 130° C., most preferably in the range from 120° C. to 130° C.

When the at least one polymer P₁ is selected from PBT and PET, and PO=PE, in another embodiment, the temperature T_{b} is preferably within a range from 80° C. to 134° C., more preferably in the range from 90° C. to 130° C., yet more preferably in the range from 100° C. to 130° C., most preferably in the range from 120° C. to 130° C.

When the at least one polymer P₁ is selected from PBT and PET, and PO=PP, in another embodiment, the temperature T_{b} is preferably within a range from 80° C. to 159° C., more preferably in the range from 90° C. to 150° C., yet more preferably in the range from 100° C. to 140° C., most preferably in the range from 120° C. to 130° C.

### 4. Step (c)

In step (c) of the process according to the invention, the glycol compound G is at least partly reacted with at least a portion of the cleavage products P₂ in the mixture M₃ to give at least one compound of structural formula (III). Structural formula (III) is as follows:

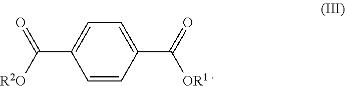

In structural formula (III), R¹ and R² are independently of one another selected from the group consisting of —H, —(CH₂)ₚ—[O—(CH₂)_{q}]ᵣ—OH, wherein preferably at least one, more preferably both, of the radicals R¹ and R² are each independently a radical of structural formula —(CH₂)ₚ—[O—(CH₂)_{q}]ᵣ—OH.

It is yet more preferable when the radicals R¹ and R² are each the same radical of structural formula-(CH₂)ₚ—[O(CH₂)_{q}]ᵣ—OH.

p is an integer where 2≤p≤6, in particular p=2 or 4, preferably p=2.

q is an integer where 2≤q≤6, in particular q=2 or 4, preferably q=2.

r is an integer where 0≤r≤10, in particular r=0 or 1, preferably r=0.

This affords a mixture M₄ comprising
the at least one polyolefin PO in the solid state,
at least one compound of structural formula (III),
optionally at least one cleavage product P₂ of structural formula (II),
optionally at least one polymer P₁,
   where the molar amount of all compounds of formula (III) in M₄ is greater than the molar amount of all compounds of structural formula (III) in the mixture M₁ used in step (a).

### 4.1 Reaction Conditions in Step (c)

The reaction in step (c) is conducted at a temperature T_{c} below the melting temperature T_{PO} of the at least one polyolefin PO encompassed by mixture M₃.

Temperature T_{c} may be equal to or different from the temperature T_{b} established in step (b).

Temperature T_{c} may be equal to or different from the temperature of mixture M₂ obtained after step (b) has ended.

In step (c) of the process according to the invention, the second portion P_{G2} of the at least one glycol compound G added to mixture M₂ in step (b) and any at least one glycol compound G from the first portion P_{G1} that has not reacted from the conversion in step (a) is reacted with the cleavage product P₂ encompassed by M₃ and any polymer P₁ encompassed by M₃ in mixture M₃, which affords at least one compound of structural formula (III).

The reaction in step (c) of the process according to the invention is accordingly conducted especially until the weight of all cleavage products P₂ and polymers P₁ in mixture M₃, and hence also in mixture M₄ obtained after step (c) has ended, has been lowered by at least 10% by weight, preferably by at least 20% by weight, more preferably by at least 30% by weight, more preferably by at least 40% by weight, more preferably by at least 50% by weight, yet more preferably by at least 60% by weight, yet more preferably by at least 70% by weight, yet more preferably by at least 80% by weight, yet more preferably by at least 90% by weight, most preferably by at least 98% by weight, based in each case on the weight of all cleavage products P₂ and polymers P₁ in mixture M₂ on addition of the second portion P_{G2} of the at least one glycol compound G in step (b).

According to the invention, “on addition of the second portion P_{G2} of the at least one glycol compound G in step (b)” is especially the first time that the second portion P_{G2} of the at least one glycol compound G makes contact with mixture M₂. In order to ascertain the weight of the polymers P₁, or of the cleavage products P₂ [or else of the compounds of structural formula (III)] in mixture M₂ at this time, a sample of this mixture M₂ can be taken five seconds before the second portion P_{G2} of the at least one glycol compound G comes into contact with mixture M₂ for the first time, and the sample can be used to ascertain the respective proportion of polymers P₁ or of cleavage products P₂ or of the compounds of structural formula (III) in mixture M₂. Alternatively, it is also possible to take samples from mixture M₂ at multiple times (sixty seconds, forty-five seconds, thirty seconds, fifteen seconds, five seconds) before the second portion P_{G2} of the at least one glycol compound G makes contact with mixture M₂ for the first time, to determine the content of polymers P₁ or of cleavage products P₂ or of the compounds of structural formula (III) in these samples, and then to extrapolate to the time of addition of the second portion P_{G2} of the at least one glycol compound G to mixture M₂.

As explained with reference to Scheme 1 for the termini of the cleavage products P₂, it is analogously also preferable in step (c) that the water content in mixture M₃ during the reaction in step (c) and especially also in the mixture M₄ obtained after step (c) has ended is at a minimum, such that, in the reaction of the glycol compound G with polymer P₁ and the cleavage product P₂, the proportion of solvolytic transesterification that leads to compounds of structural formula (III) in which both R¹, R² radicals≠H is at a maximum, and the proportion of hydrolytic ester cleavage that leads to compounds of structural formula (III) in which at least one of the R¹, R² radicals=H is at a minimum. The reason for this is that compounds of structural formula (III) with R¹, R²≠H can be more readily polymerized back to polymers P₁. If the process according to the invention is used in the course of reprocessing of polymers P₁, it is advantageous to maximize the proportion of compounds of structural formula (III) with R¹, R²≠H in the resultant mixture M₄ and to minimize the proportion of compounds of structural formula (III) in which at least one of, preferably both of, R¹, R²=H in the resultant mixture M₄.

It is thus advantageous to keep the water content in mixture M₃ as low as possible during the reaction in step (c).

In a preferred embodiment of the present invention, the water content in mixture M₃ during the reaction in step (c) is therefore <10% by weight, more preferably <5% by weight, yet more preferably <1% by weight, yet more preferably <0.1% by weight, most preferably <0.01% by weight, based in each case on the total weight of mixture M₃.

The reaction of mixture M₃ in step (c) of the process according to the invention is conducted at a temperature T_{c} below the melting temperature T_{PO} of the at least one polyolefin PO encompassed by mixture M₃. As a result, the polyolefin PO is in solid form in mixture M₃ during the reaction according to step (c). This prevents the formation of viscous agglomerates of PO that are difficult to separate off.

When the polyolefin PO is selected from PE and PP, temperature T_{c} is preferably within a range from 80° C. to 134° C., more preferably in the range from 90° C. to 130° C., yet more preferably in the range from 100° C. to 130° C., most preferably in the range from 120° C. to 130° C.

When the at least one polymer P₁ is selected from PBT and PET, and PO=PE, in another embodiment, temperature T_{c} is preferably within a range from 80° C. to 134° C., more preferably in the range from 90° C. to 130° C., yet more preferably in the range from 100° C. to 130° C., most preferably in the range from 120° C. to 130° C.

When the at least one polymer P₁ is selected from PBT and PET, and PO=PP, in another embodiment, temperature T_{c} is preferably within a range from 80° C. to 159° C., more preferably in the range from 90° C. to 150° C., yet more preferably in the range from 100° C. to 140° C., most preferably in the range from 120° C. to 130° C.

Step (c) of the process according to the invention can be conducted in any reaction vessel known to the person skilled in the art, and is preferably conducted in a reactor (e.g. autoclave), preferably in a stirred tank reactor.

In addition, it is also possible to conduct step (c) in a kneader or extruder E, preferably in an extruder E.

Extruders E used in a preferred embodiment are piston extruders or multi-shaft extruders, particular preference being given to multi-shaft extruders.

Preferred multi-screw extruders are planetary roller extruders or multi-screw extruders, in particular twin-screw extruders.

In another preferred embodiment, step (c) is conducted at least partly in a reactor, especially a stirred tank reactor.

If step (a) is conducted in an extruder E, in a preferred embodiment, at least part of step (b) and all of step (c) are conducted in a reactor, especially a stirred tank reactor.

Alternatively, steps (a) to (c) of the process according to the invention may also be conducted in an extruder E.

### 4.2 Catalyst K₂

It is advantageous that the reaction of the glycol compound G with the cleavage product P₂ in the mixture M₃ in step (c) is performed in the presence of at least one catalyst K₂.

The catalyst K₂ may already be present in the mixture M₃ prior to addition of the at least one glycol compound G [for example in the form of residues of the catalyst K₁ used in the preferred embodiment of step (a)], be added to the mixture M₃ after addition of the at least one glycol compound G, and/or be added to the mixture M₃ together with the at least one glycol compound G.

The catalyst K₂ may be selected by a person skilled in the art according to their knowledge in the art.

The catalyst K₂ is preferably selected from the group consisting of carbonates, hydrogencarbonates, metal halides, amines, alkoxides, acetates, phosphates, dibutyltin oxide, more preferably from the group consisting of amines, alkoxides, acetates; yet more preferably, the catalyst K₂ is an alkoxide, yet more preferably an alkali metal alkoxide.

A preferred acetate is selected from the group consisting of lead acetate, zinc acetate, wherein zinc acetate is more preferred.

Preferred phosphates are alkali metal phosphates, in particular sodium phosphate.

A preferred metal halide is zinc chloride.

Preferred carbonates are alkali metal carbonates or alkaline earth metal carbonates, in particular alkali metal carbonates, preferably sodium carbonate.

Preferred hydrogencarbonates are alkali metal hydrogencarbonates or alkaline earth metal hydrogencarbonates, in particular alkali metal hydrogencarbonates, preferably sodium hydrogencarbonate.

Amines used are preferably trialkylamines, for example trimethylamine, triethylamine, dimethylethylamine, di(iso-propyl)ethylamine (“DIPEA”) or cyclic amines, for example 1,5,7-triazabicyclo[4.4.0]dec-5-ene (“TBD”) or 1,8-diazabicyclo[5.4.0]undec-7-ene (“DBU”).

If the catalyst K₂ used is an alkoxide, in particular an alkali metal alkoxide, it is preferably used in solid form, for example in the form of a powder or granules.

Preferred alkoxides are alkali metal alkoxides, wherein the alcohol is a monohydric or dihydric alcohol having 1 to 6 carbon atoms

Yet more preferred alkali metal alkoxides are those wherein the alkoxide is selected from the group consisting of
methoxide;
ethoxide;
propoxide, meaning n-propoxide or iso-propoxide;
butoxide, in particular n-butoxide;
pentoxide, in particular n-pentoxide;
hexoxide, in particular n-hexoxide;
ethyleneglycolate;
   more preferably selected from methoxide, ethoxide, ethyleneglycolate, yet more preferably selected from methoxide, ethoxide and most preferably selected from methoxide.

Preferred alkali metals here are lithium, sodium, potassium, more preferably sodium, potassium, yet more preferably sodium.

In a particularly preferred embodiment, the catalyst K₂ is selected from the group consisting of sodium ethyleneglycolate, potassium ethyleneglycolate, potassium methoxide, sodium methoxide, potassium ethoxide, sodium ethoxide, more preferably selected from the group consisting of potassium methoxide, sodium methoxide, potassium ethoxide, sodium ethoxide, yet more preferably selected from the group consisting of sodium methoxide, potassium ethoxide, sodium ethoxide; particularly preferably, K₂=sodium methoxide.

The amount of the catalyst K₂ used in step (c) may be chosen by a person skilled in the art according to their knowledge in the art. The molar amount of all catalysts K₂ used in step (c), based on the molar amount of all glycol compounds G added as the second portion P_{G2} in step (b), is in particular in the range from 0.01% to 10%, preferably in the range from 0.1 to 5%, more preferably in the range from 1% to 4%, yet more preferably in the range from 2.5% to 3.5%, especially preferably 3%.

### 4.3 Mixture M₄

After step (c) of the process according to the invention has ended, a mixture M₄ is obtained. This comprises the at least one compound of structural formula (III) and the at least one polyolefin PO in the solid state, with or without at least one cleavage product P₂ and with or without at least one polymer P₁.

Mixture M₄ after step (c) has ended is at a temperature below the melting temperature of the polyolefin PO. The exact temperature at which the mixture M₄ is obtained after step (c) has ended may, but need not, be that temperature T_{c} at which the reaction in step (c) took place. All that is essential to the invention is that mixture M₄ after step (c) has ended is obtained at a temperature below the melting temperature of the polyolefin PO. In a preferred embodiment, the mixture M₄ after step (c) has ended is at the temperature T, at which the reaction in step (c) was conducted.

The mixture M₄ may also comprise at least one cleavage product P₂, and the mixture M₄ may also comprise at least one polymer P₁. This is the case, for example, when not all cleavage products P₂ or polymers P₁ encompassed by mixture M₃ have reacted with the at least one glycol compound G in step (c) of the process according to the invention, for example when the second portion P_{G2} of the glycol compound G has been used in step (c) in molar deficiency based on the repeating units W₃ encompassed by the polymers P₁ and cleavage products P₂ in mixture M₃ (described in Section 2.6).

In a preferred embodiment, mixture M₄ comprises at least one cleavage product P₂ and, yet more preferably, additionally at least one polymer P₁.

The mixture M₄ may also comprise at least one glycol compound G.

In a yet more preferred embodiment, mixture M₄ comprises at least one cleavage product P₂, at least one polymer P₁ and at least one glycol compound G.

It is at least the case that the molar amount of all compounds of structural formula (III) in the mixture M₄ obtained after step (c) has ended is greater than the molar amount of all compounds of structural formula (III) in the mixture M₁ used in step (a).

This is merely because, in step (c) of the process according to the invention, at least a portion of the cleavage products P₂ in mixture M₃ and, if present in mixture M₃, at least a portion of the polymers P₁ are reacted with the at least one glycol compound G to give at least one compound of structural formula (III). By means of establishment of suitable reaction conditions (for example the amount of the at least one glycol compound G added as the second portion P_{G1}, reaction time), the person skilled in the art can also set conditions so as to obtain a maximum molar amount of compounds of structural formula (III) in M₄.

What is meant more particularly by “mixture M₁ used in step (a)” in the context of the invention is “in mixture M₁ on addition of the first portion P_{G1} of the at least one glycol compound G in step (a)”.

According to the invention, “on addition of the first portion P_{G1} of the at least one glycol compound G in step (a)” is especially the first time that the first portion P_{G1} of the at least one glycol compound G makes contact with mixture M₁. In order to ascertain the weight of the polymers P₁, or of the cleavage products P₂ [or else of the compounds of structural formula (III)] in mixture M₁ at this time, a sample of this mixture M₁ can be taken five seconds before the first portion P_{G1} of the at least one glycol compound G comes into contact with mixture M₁ for the first time, and this sample can be used to ascertain the respective proportion of polymers P₁ or of cleavage products P₂ or of the compounds of structural formula (III) in mixture M₁. Alternatively, it is also possible to take samples from mixture M₁ at multiple times (sixty seconds, forty-five seconds, thirty seconds, fifteen seconds, five seconds) before the first portion P_{G1} of the at least one glycol compound G makes contact with mixture M₁ for the first time, to determine the content of polymers P₁ or of cleavage products P₂ or of the compounds of structural formula (III) in these samples, and then to extrapolate to the time of addition of the first portion P_{G1} of the at least one glycol compound G to mixture M₁.

In the optional embodiment of the invention in which the mixture M₄ obtained after step (c) has ended also comprises at least one cleavage product P₂, it is preferable when at least one of the following conditions (α**), (β**) are met, more preferably at least condition (β**) is met, and preferably both conditions (α**) and (β**) are met:
(α**) the average degree of polymerization ρ₂₄ of all cleavage products P₂ encompassed by mixture M₄ after step (c) has ended is lower than the average degree of polymerization ρ₂₂ of all cleavage products P₂ encompassed by mixture M₂ on addition of the second portion P_{G2} of the at least one glycol compound G in step (b);
(β**) the molar amount of all cleavage products P₂ encompassed by mixture M₄ after step (c) has ended is smaller than the molar amount of all cleavage products P₂ encompassed by mixture M₂ on addition of the second portion P_{G2} of the at least one glycol compound G in step (b).

In the optional embodiment of the invention in which the mixture M₄ obtained after step (c) has ended also comprises at least one polymer P₁, it is preferable when at least one of the following conditions (α***), (β***) are met, more preferably at least condition (β***) is met, and preferably both conditions (α***) and (β***) are met:
(α***) the average degree of polymerization ρ₁₄ of all polymers P₁ encompassed by mixture M₄ after step (c) has ended is smaller than the average degree of polymerization ρ₁₁ of all polymers P₁ encompassed by the mixture M₁ used in step (a);
(β***) the molar amount of all polymers P₁ encompassed by mixture M₄ after step (c) has ended is smaller than the molar amount of all polymers P₁ encompassed by the mixture M₁ used in step (a).

### 4. Step (d)

In step (d) of the process according to the invention, the solid polyolefin PO is at least partly separated from mixture M₄.

This separation can be conducted by methods familiar to the person skilled in the art, preferably by gravimetric means or by filtration, more preferably by filtration.

Gravimetric separation methods are, for example, decantation or centrifugation.

In step (d), the advantage of the process according to the invention is realized, which is that the polyolefin PO that was present in the starting mixture M₁ can be separated easily and efficiently from the mixture M₄ obtained after step (c) of the process according to the invention has ended.

### 5. Contaminant V

In a preferred embodiment, mixture M₂, as well as the at least one cleavage product P₂ and the melt of the at least one polyolefin PO, also comprises at least one solid contaminant V. The solid contaminant V may be organic or inorganic.

The solid contaminant V is preferably selected from the group consisting of paper, metal, metal oxides, fibres, which are especially textile fibres, ash, sand, spall, soil, plastics P_{F} other than P₁ and PO, and more preferably from the group consisting of plastics P_{F}, ash, sand.

The plastic P_{F} is especially a plastic having a higher melting temperature than the at least one PO (and especially also having a higher melting temperature than the at least one polymer P₁). Alternatively, in particular, the plastic P_{F} does not have a melting temperature, but rather a glass transition temperature.

More preferably, the plastic P_{F} is selected from the group consisting of polycarbonates.

The at least one solid contaminant V encompassed by mixture M₂ in this embodiment typically originates from the corresponding contaminant in the mixture M₁ used in step (a). In a preferred embodiment of the present invention, therefore, the mixture M₁ used in step (a) and the mixture M₂ comprise at least one solid contaminant V.

The process according to the invention is particularly suitable for depolymerization of polymers P₁, especially PET or PBT, which, in the context of wastes, exist not only as a mixture with PO, but also in a mixture with further solid contaminants V. Such solid contaminants V then recur at least partly in the mixture M₂ obtained after step (a). They may in principle be separated from mixtures M₁, M₂, M₃ or M₄ during or after the process according to the invention (for example by filtration or gravimetric methods).

In a preferred embodiment of the present invention, the mixture M₂, as well as the at least one cleavage product P₂ and the melt of the at least one polyolefin PO, also comprises at least one solid contaminant V, wherein the solid contaminant V is separated at least partly from the mixture M₂ before the mixture M₂ is cooled in step (b) to a temperature below the melting temperature of the at least one polyolefin PO (“preferred embodiment O”).

This separation can be conducted by methods familiar to the person skilled in the art, preferably by gravimetric means or by filtration, more preferably by filtration.

Gravimetric separation methods are, for example, decantation or centrifugation.

This embodiment additionally contributes to the surprising effect on which this invention is based. As described for step (b) (point 3.), in comparative processes in which the at least one polymer P₁ is reacted with at least one glycol compound G at a temperature >T_{PO} throughout, i.e. in a reaction mixture in which PO is in molten form throughout, and the reaction mixture is lowered to a temperature below the melting temperature of PO only after the reaction has ended, there is the problem that the solidified polyolefin PO can be separated from the remainder of the crude product only in a complex manner and inefficiently. This problem is aggravated when the starting mixture includes further solid contaminants V. When they are present in the resulting reaction mixture on solidification of the PO after conclusion of the depolymerization, these additionally make it difficult to separate off the solidified PO since they can form inclusions with PO on solidification and make them inhomogeneous aggregates.

This problem is solved by the additional embodiment O. This is because, in this embodiment, the solid contaminant V is removed at a time when the polyolefin PO is in molten form, i.e. in the liquid state of matter, in mixture M₂, which simplifies the separation and prevents the formation of inclusions, for example, when PO solidifies in the presence of the at least one contaminant V.

### EXAMPLES

### Inventive Example

The reduction is conducted in a twin-screw extruder (ratio of length to diameter=33; screw diameter 30 mm) with housing sections, the wall temperature of which can be set at different levels. At the extruder inlet, 3.8 kg/h PET flakes and 0.2 kg/h of polyethylene pellets are metered in gravimetrically and brought into the process space at housing temperature 70° C. In the housing downstream (housing temperature: 265° C.), the polymer fractions metered in are melted. A 4% by weight solution of sodium ethyleneglycolate in ethylene glycol is injected into the melt. The mass flow ratio of sodium ethyleneglycolate solution to PET is 1. The housing temperature directly downstream of the injection site is likewise 265° C., and is lowered to 130° C. toward the extruder exit. At the extruder exit, a pasty mixture of BHET and BHET oligomers (i.e. cleavage products P₂ with n₂<49, with the main portion at n₂<20) in ethylene glycol and agglomerates of polyethylene is discharged.

The extruder output is collected and, in a subsequent step, reacted with further ethylene glycol in a stirred tank reactor. The weight ratio of ethylene glycol, based on the extruder output used, is 5:1. An initial charge of ethylene glycol in the reactor is heated to 100° C., and the now solidified reactor output is added. A greyish suspension is formed while stirring. The temperature is increased to 130° C. and is thus below the melting temperature of PE (135° C.). 3% by weight of sodium methoxide (solution in methanol), based on the extruder output used, is added. Within 15 minutes, a transparent solution having the main components ethylene glycol and BHET is formed. The polyethylene agglomerates present in the extruder output do not change in morphology, do not float, i.e. are not deposited on the stirrer shaft, and can be easily filtered off.

### Comparative Example

Inventive example 1 is repeated, except that the extruder output is heated in the stirred tank reactor to 160° C. rather than to 130° C. before the sodium methoxide solution (in methanol) is added. The result is a transparent solution in which the PE agglomerates do not float, but form viscous polyethylene coagulate that winds around the shaft and can be removed with difficulty.

### Result

The glycolysis of the PET in the PET/PE mixture in a two-stage process with the different temperature levels (1st step at a temperature above the melting temperature of the polyolefin, in this case polyethylene; 2nd step at a temperature below the melting temperature of the polyethylene) allows PE-contaminated PET fractions to be broken down by solvolysis within an economically viable reaction time, and the polyolefin contaminant to be separated efficiently from the resultant crude product.

Thus, the process according to the invention enables the depolymerization of wastes comprising polymers P₁ such as PET and PBT that are contaminated with polyolefins, for example PE. The first reaction step thus achieves partial conversion within a short reaction time. The depolymerized material obtained in the first step can then be broken down further in the second reaction stage within a short time at low temperatures, especially to give the monomer, e.g. BHET. The effect of the inventive adjustment of temperature in the two steps that are undertaken depending on the melting temperature of the contaminating polyolefin is accordingly that molten and resolidified polyolefin contaminants can easily be separated from the end product and hence do not impair the process.

### Analysis

According to the invention, the molecular weight distributions of the polymers P₁ and the cleavage products P₂ (and hence the average degree of polymerization ρ in a given mixture) are ascertained by gel permeation chromatography (“GPC”) as in Method 1 that follows. Method 1 is based on the methodology on page 356 of the article M. R. Milana, M. Denaro, L. Arrivabene, A. Maggio, L. Gramiccioni, Food Additives and Contaminants, 1998, 15, 355-361.

### Method 1

1. A sample of the mixture to be examined is diluted in a weight ratio of 1:333 in 1,1,1,3,3,3-hexafluoro-2-propanol (“HFIP”) and dissolved at room temperature for 24 hours.

2. The solution is filtered through a 1 μm disposable polytetrafluoroethylene filter and injected with an autosampler for analysis.

3. The following size exclusion chromatography (“GPC”) system was used:
Eluent: HFIP/0.05 M KTFAc (=potassium trifluoroacetate)
Precolumn: PSS PFG, 7 μm, guard, ID 8.00 mm×50.00 mm
Columns: PSS PFG, 7 μm, 100 Å, ID 8.00 mm×300.00 mm
   PSS PFG, 7 μm, 100 Å, ID 8.00 mm×300.00 mm
   PSS PFG, 7 μm, 300 Å, ID 8.00 mm×300.00 mm
Pump: PSS-SECcurity 1260 HPLC pump
Flow rate: 1.0 ml/min
Injection system: PSS-SECcurity 1260 Autosampler
Injection volume: 50 μl
Sample concentration: 3.0 g/L
Temperature: 30° C.
Detectors: SECcurity² differential refractometer detector (RI)
Evaluation: PSS-WinGPC UniChrom Version 8.4

4. Calibration is effected by means of a PMMA standard (PMMA=polymethylmethacrylate) in the separation region of the column combination. The molar mass averages and the distribution thereof, which give the average degree of polymerization ρ in a given mixture, are calculated with computer assistance and are based on PMMA calibration by the strip method.

1-16. (canceled)

17. A process for depolymerizing at least one polymer P₁, wherein the at least one polymer P1 comprises n₁ interlinked repeating units of the following structural formula (I): 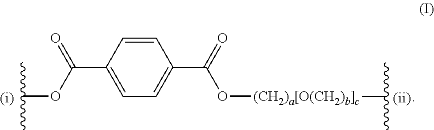
wherein a is an integer for which 2≤a≤6,
wherein b is an integer for which 2≤b≤6,
wherein c is an integer for which 0≤c≤10,
wherein n₁ is an integer ≥50,
wherein the n₁ interlinked repeating units of structural formula (I) encompassed by the polymer P₁ are the same or different,
and wherein the n₁ interlinked repeating units of structural formula (I) are interlinked within the polymer P₁ in such a way that the bond of the one repeating unit of structural formula (I) labelled “(i)” is linked to the bond of the adjacent repeating unit of the structural formula (I) labelled “(ii)”,
comprising the following steps:
(a) adding a first portion P_{G1} of at least one glycol compound G having structural formula (V): HO—(CH₂)_{d}—[O—(CH₂)ₑ]_{f}—OH,
wherein d is an integer for which 2≤d≤6,
wherein e is an integer for which 2≤e≤6,
wherein f is an integer for which 0≤f≤10,
to give a mixture M₁ comprising
the at least one polymer P₁,
a melt of at least one polyolefin PO having a lower melting temperature T_{PO} than the melting temperature T_{P1} of the at least one polymer P₁,
and at least partly reacting the glycol compound G with at least a portion of the polymers P₁ in the mixture M₁ to give at least one cleavage product P₂,
wherein the cleavage product P₂ has the structural formula (II): 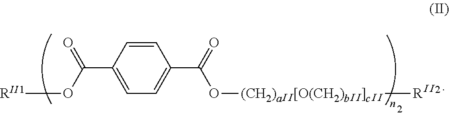
wherein a^{II} is an integer for which 2≤a^{II}≤6,
wherein b^{II} is an integer for which 2≤b^{II}≤6,
wherein c^{II} is an integer for which 0≤c^{II}≤10,
wherein n₂ is an integer for which 2≤n₂≤48,
wherein units W₂ are interlinked within the cleavage product P₂, and each unit W₂ conforms to the structure in the parentheses indexed with “n₂” in structural formula (II), and the units W₂ are identical or different within the cleavage product P₂,
where R^{II1} is selected from the group consisting of —H, and —(CH₂)_{a♥}—[O—(CH₂)_{b♥}]_{c♥}—OH, and
wherein a_{♥} is an integer for which 2≤a_{♥}≤6,
wherein b_{♥} is an integer for which 2≤b_{♥}≤6,
wherein c_{♥} is an integer for which 0≤c_{♥}≤10,
where R^{II2} is selected from the group consisting of —H, —OH, a radical of the structural formula (IV): 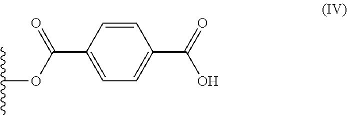
and wherein step (a) is conducted at a temperature Tₐ above the melting temperature T_{PO} of the at least one polyolefin PO,
so as to obtain a mixture M₂ comprising:
at least one cleavage product P₂,
a melt of the at least one polyolefin PO,
and wherein the molar amount of all cleavage products P₂ in the mixture M₂ is greater than the molar amount of all cleavage products P₂ in the mixture M₁ used in step (a);
(b) cooling the mixture M₂ to a temperature T_{b} below the melting temperature T_{PO} of the at least one polyolefin PO,
wherein, during and/or after the cooling of the mixture M₂ to the temperature T_{b}, a second portion P_{G2} of at least one glycol compound G of the structural formula (V) is added to the mixture M₂, so as to obtain a mixture M₃ comprising:
at least one cleavage product P₂,
the at least one polyolefin PO in the solid state,
at least one glycol compound G,
(c) at least partly reacting the glycol compound G with at least a portion of the cleavage products P₂ in the mixture M₃ to give at least one compound of structural formula (III): 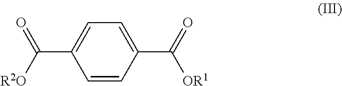
wherein R¹ and R² are independently selected from the group consisting of —H, and —(CH₂)ₚ—[O—(CH₂)_{q}]ᵣ—OH,
wherein p is an integer for which 2≤p≤6,
wherein q is an integer for which 2≤q≤6,
wherein is an integer for which 0≤r≤10,
wherein the reaction in step (c) is conducted at a temperature T_{c} below the melting temperature T_{PO} of the at least one polyolefin PO, which affords a mixture M₄ comprising
the at least one polyolefin PO in the solid state,
at least one compound of structural formula (III),
wherein the molar amount of all compounds of structural formula (III) in M₄ is greater than the molar amount of all compounds of structural formula (III) in the mixture M₁ used in step (a),
(d) at least partly separating the solid polyolefin PO from the mixture M₄.

18. The process of claim 17, wherein the mixture M₂, including the at least one cleavage product P₂ and the melt of the at least one polyolefin PO, further comprises at least one solid contaminant V, which is at least partly removed from the mixture M₂ before it is cooled in step (b) to a temperature below the melting point of the polyolefin PO.

19. The process of claim 17, wherein the reaction in step (a) is conducted until the weight of all polymers P₁ in the mixture M₂ has fallen by at least 10% by weight, based on the weight of all polymers P₁ in the mixture M₁ used in step (a).

20. The process of claim 17, wherein the molar amount of all glycol compounds G added as the first portion P_{G1} to the mixture M₁ in step (a) is ≥0.01 molar equivalent, based on the molar amount of all repeating units of structural formula (I) encompassed by the polymers P₁ in the mixture M₁ used in step (a).

21. The process of claim 17, wherein the reaction of the glycol compound G with the cleavage product P₂ in the mixture M₃ in step (c) is conducted in the presence of at least one catalyst K₂.

22. The process of claim 21, wherein the catalyst K₂ is selected from the group consisting of carbonates, hydrogencarbonates, metal halides, amines, alkoxides, acetates, phosphates, and dibutyltin oxide.

23. The process of claim 17, wherein the reaction of the glycol compound G with the polymer P₁ in the mixture M₁ in step (a) is conducted in the presence of at least one catalyst K₁.

24. The process of claim 23, wherein the catalyst K₁ is selected from the group consisting of carbonates, hydrogencarbonates, metal halides, amines, alkoxides, acetates, phosphates, and dibutyltin oxide.

25. The process of claim 17, wherein the water content in the mixture M₁ during the reaction in step (a) is <10% by weight, based on the total weight of the mixture M₁.

26. The process of claim 17, wherein the water content in the mixture M₃ during the reaction in step (c) is <10% by weight, based on the total weight of the mixture M₃.

27. The process of claim 17, wherein the at least one polyolefin PO is selected from the group consisting of: polyethylene, polypropylene, polyisobutylene, and polybutylene.

28. The process of claim 17, wherein the at least one polymer P₁ is selected from the group consisting of polyethylene terephthalate, polybutylene and terephthalate.

29. The process of claim 17, wherein step (a) is conducted at least partly in a kneader or extruder E.

30. The process of claim 17, wherein step (c) is conducted at least partly in a stirred tank reactor.

31. The process of claim 17, wherein the second portion P_{G2} of the at least one glycol compound G is added to the mixture M₂ in step (b) after the mixture M₂ has been cooled to the temperature T_{b}.

32. The process of claim 17, wherein the ratio of the molar amount of all cleavage products P₂ of structural formula (II) in the mixture M₁ used in step (a) to the molar amount of all polymers P₁ in the mixture M₁ used in step (a) is <1:1, and the ratio of all cleavage products P₂ of structural formula (II) in the mixture M₂ on addition of the second portion P_{G2} of the at least one glycol compound G in step (b) to the molar amount of all polymers P₁ in the mixture M₂ on addition of the second portion P_{G2} of the at least one glycol compound G in step (b) is ≥1:1.

33. The process of claim 27, wherein the at least one polymer P₁ is selected from the group consisting of polyethylene terephthalate, polybutylene and terephthalate.

34. The process of claim 33, wherein step (a) is conducted at least partly in a kneader or extruder E.

35. The process of claim 34, wherein step (c) is conducted at least partly in a stirred tank reactor.

36. The process of claim 35, wherein the second portion P_{G2} of the at least one glycol compound G is added to the mixture M₂ in step (b) after the mixture M₂ has been cooled to the temperature T_{b}.
